(19) United States
(12) Patent Application Publication
(10) Pub. No.: US 2022/0027912 A1
(43) Pub. Date: Jan. 27, 2022

(54) CRYPTOGRAPHIC PHYSICAL RANDOM OBJECT

(71) Applicant: David CHAUM, Sherman Oaks, CA (US)

(72) Inventor: David CHAUM, Sherman Oaks, CA (US)

(21) Appl. No.: 17/381,504

(22) Filed: Jul. 21, 2021

Related U.S. Application Data
(60) Provisional application No. 63/054,505, filed on Jul. 21, 2020.

(51) Int. Cl. G06Q 20/40; H04L 9/32; G06K 19/04; G06Q 20/38

(52) U.S. Cl. CPC G06Q 20/409; H04L 9/3236; G06K 19/06037; G06Q 20/3829; G06Q 20/3825; G06K 19/041

(57) ABSTRACT

A value transfer system with physical tokens including indicia hiding means and indica substantially hidden by the hiding means and the hiding being substantially removable is improved by providing a plurality of regions with substantially removable hiding means, with the hiding means substantially hiding respective indicia. The indicia information is substantially unpredictable. As part of the system, a first party provides digitally to at least a second party first transaction information at least including a provenience signature ensemble, with the signature ensemble including at least indication of the regions with hiding removed.

### BACKGROUND

A major problem in electronic payments has been the absence of secure operation offline. Trusted chip solutions, such as Mondex, have apparently been abandoned it is believed because the required infrastructure is lacking and because of security considerations. Also advantageous would be new security principles for what the present applicant originally dubbed the “double spending problem.” Secure offline value transfer, using already widely deployed infrastructure, is addressed by the present application, including novel solutions to double spending.

### SUMMARY OF THE INVENTION

The invention is an improvement in value transfer systems with physical tokens including indicia hiding means and indica substantially hidden by the hiding means and the hiding being substantially removable. The improved system includes a plurality of regions with substantially removable hiding means, the hiding means substantially hiding respective indicia. The indicia information can be substantially unpredictable. A first party provides digitally to at least a second party first transaction information at least including a provenience signature ensemble; and the signature ensemble including at least indication of the regions with hiding removed. Random physical structure can thwart cloning and destruction of printed information can protect the party who has removed the hiding means before the information indicia is destroyed.

One embodiment of the invention relates to the size and thickness of a credit card. The card includes micro-glitter randomly dispersed in its clear plastic substrate, making each card unique and infeasible to clone. Apparatus, such as smartphones, especially with lights, can, it is believed, readily recognize the micro-glitter pattern and ensure that the object presented is according to the signatures. Denominations, such as those familiar on banknotes, can label the rows of scratch-offs on the card. Hidden under each scratch-off can be secret information encoded in indicia such as a random two-dimensional barcode.

Thick dashed lines in the figures indicate perforations physically penetrating through the thickness of the card. This or similar frangible structure is intended to allow individual squares or whatever tile shape to easily be removed with their scratch-off intact. Some example tiles are shown black in the figures to indicate that they have been physically removed.

The use of checkerboard-like two-dimensional barcode structures shown are more efficient for random numbers than standard QR codes. Each such barcode represents an unpredictable cryptographic key of what is believed adequate, about one hundred bits. Advantageous is that in some examples each can be checked for match with a corresponding cryptographic “one-way function” image published when the card was printed. The use of multiple colors within each barcode allows the checkerboard to be even more compact. Current smartphone camera resolution is believed to already allows smaller features and thus many more scratch-offs and checkerboards on a card than are illustrated.

In some cases, the holder may have purchased the card at face value, the denominations multiplied by the number of squares per row; in other cases, where cards serve as a backup for the contingency of network failure, the holder may for instance be provided the card at no cost. Different “color series” of cards may be issued, some for emergencies where credit is granted to the person issued the card if an emergency occurs and other series that are sold at face value. A single card might even have two differently colored regions. Such an approach has the advantage that the cards become attractive to hold for various contingencies as well as for regular use in a variety of cases. These dual uses are complementary, since build-out and exercise of mechanisms for ordinary use provide readiness in case infrastructure failure were to cause a contingency color series to be activated.

Suppose there is no network connection but the holder of a card wishes to pay for something from a shop. (If there were network, an online payment system could be used instead; in which case value could also be taken from the card.) The scratch-off regions for the amount of payment are scratched off by the holder or shopkeeper, ideally only while the shopkeeper smartphone/camera can view the card.

The card holder's smartphone provides the shop's smartphone, such as by Bluetooth, a digital signature originally obtained from the card supplier. The signature can in some examples “digitally sign,” that is irrefutably authenticate, three things: One thing digitally signed by the issuer is a so-called “hash tree” of encrypted images of the barcode keys, which lets the validity of any key be efficiently and definitively checked. A second thing signed is the pattern of glitter reflection angles, like the database of stars that lets astronomers identify any view of the sky, allowing a smartphone to very securely recognize that the physical card and/or region is not a clone. The third thing digitally signed by the issuer is a public key of the holder's smartphone, which allows that phone, in turn, to make signatures that are verifiably on behalf of the cardholder.

The shopkeeper's smartphone can in this example then check that the card is genuine and that the barcodes revealed really do unlock the encryptions. The cardholder's phone can then form its own digital signature, which only it can make, for instance on: the amount that is remaining on the card, the amount paid, and the shop account. The shop's smartphone can, using its camera and the information digitally signed by the issuer, verify all of this and accept the payment. (The shopkeeper could even be allowed to break out one of the squares or simply use an abrasive ink eraser or a moistened wipe to remove the indicia from the card so as to keep a barcode from the cardholder; this can it is believed ensures that nobody else got that barcode and thereby makes the transaction ultra-secure and instantly clearable at any time online.)

Suppose that instead of a shop, the payment was made to an unbanked person with a smartphone, such as in a remote area without online access. The same protections of the value would be provided to that person receiving the payment, who could then at any later point redeem it online, such as during an occasional visit to a retail location acting as intermediary.

If the smartphone of the cardholder or that of the shop are somehow not available, perhaps because of lack of battery charge, a damaged phone, or even a lost or stolen phone, ideally payment would still be practical—but if the same problem is everywhere for everyone because of infrastructure failure, payment may become critical for necessities on a large scale. An example of how such use cases can be handled is by some of the tiles on the card being removed. Each removed tile has its denomination printed on it, shown in the example on the back. A variety of special printing and inks and document security features like holograms from banknote security can be used to provide an acceptably high level of authentication. Hence, when a person removes these tiles from a card, they can be pretty confident that the tiles do represent specific amounts of money, each like a banknote with its denomination. The tiles can even be passed from person to person, much like coins or banknotes. Ultimately, when someone wishes to upload the value from a tile, they scratch it off and upload a picture of the barcode or its information. This is readily checked as genuine by the issuer, who can then, for instance, make the value available online in favor of the person who uploaded.

Smart-card chips, with or without contacts, even along with a standard magnetic stripe and signature panel, can be accommodated on either side of what can be an ISO standard card. This can help make a card something that people may wish to carry and use and thus have at the ready in case needed. The phones-offline and no-phone-needed scenarios are believed to potentially provide some ongoing use. Also, financial incentive can be provided to some users and/or merchants selectively to accept the payments during normal operation. Thus, it is believed that the system can be kept truly ready in case of infrastructure failure and that it can securely return the value online afterwards.

### DETAILED DESCRIPTION

Detailed descriptions will now be provided to enable those of skill in the art to make and use; however, various inventive aspects will be illustrated by examples that should not be taken to limit the scope of the invention in any way.

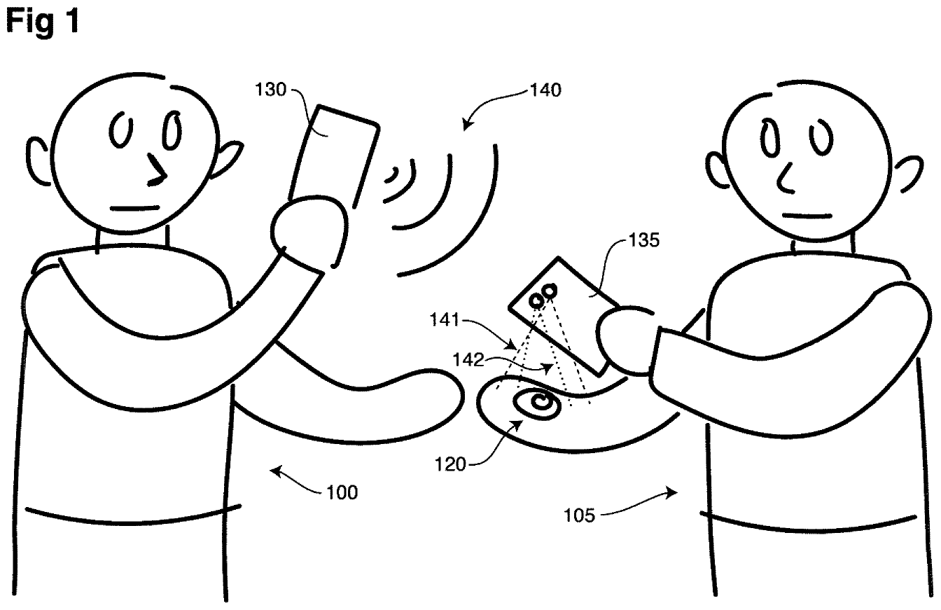

Turning now to FIG. 1, a detailed description of an overall exemplary embodiment and use case for a physical transfer of cryptographic value in accordance with the teachings of the present invention will now be described. Two example users are shown exchanging a physical item using a respective device of each.

The first user 100 can be seen just having handed the physical element or what may be here called a “carrier of value,” in the exemplary form factor roughly similar to that of a coin 120 (to be described in more detail below), to the second user 105 in the example. The paying user 100 provides additional digital information (to be described in more detail below) by use of device 130 to the receiving party 105 by, in the example for clarity, radio frequency communication 140 to the device of the receiving party 135, and responds to further information, not shown for clarity (to be described in more detail below), provided by the receiving device 135. The receiving party device 135 can, in the example shown, optionally provide illumination shown as dashed lines 141 and capture optical imagery shown as dotted lines 142 (as will be described in more detail below).

In some examples the portable devices can be so-called “smartphones” that are running suitable so-called “app” software and using various incorporated electromagnetic communication means as well as image capture and illumination hardware components and performing user interface and cryptographic protocol operations. Various inertial navigation devices can also be employed in some exemplary embodiments to help determine positioning and motion during image capture and optionally guide one or more users. An exemplary app of the receiving party may include providing what may here be called “illumination,” “image capture,” “alignment,” and “recognition” of the object, as will be well known and understood in the machine vision art.

In some examples to be described in more detail later: the participants communicate online before and/or after the exchange, physical transfer of paper or scratch-off may also accompany the transfer, the object recognizably/irreversibly altered, and/or there may be communication with a device embedded in the coin.

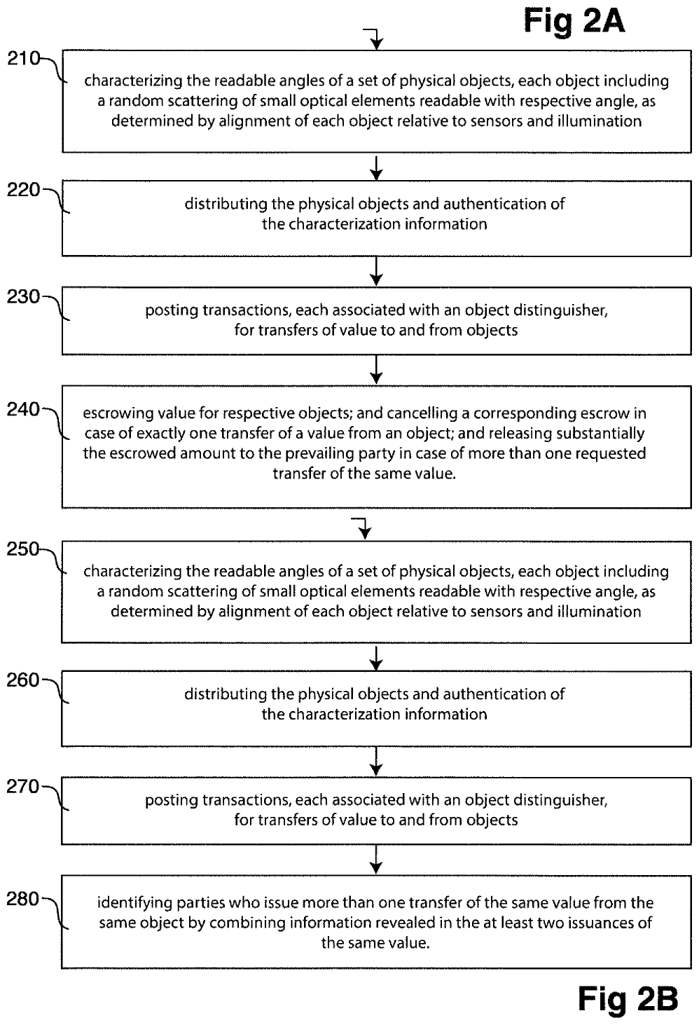

Turning to FIG. 2AB, detailed description flowcharts of overall exemplary embodiments of a physical transfer of cryptographic value in accordance with the teachings of the present invention will now be described. FIG. 2A includes the exemplary aspect of an escrow of a value released in case of no dispute or resolution of a dispute; FIG. 2B includes the optionally combinable and/or separate exemplary aspect of an identity that is with high likelihood revealed when multiple transfers of the same value are made.

Referring first to FIG. 2A, box 210 begins by at least one first entity characterizing the readable angles of a set of physical objects, each object including a what may here be called a “random scattering of small optical elements” what may here be called “recognizable” with respective angle, as determined by alignment of each object relative to sensors and illumination. It will be appreciated that a random scattering of small optical elements is any non-homogenous at least somewhat transparent physical structure that has any distinguishing optical characteristics when illuminated so that it can be recognised to the extent that it can be distinguished with reasonable probability from other similar such objects and it is at least believed somewhat difficult to create other objects that can not be so distinguished. What is meant by “scattering: is any natural, man made, or combination process that distributes, re-arranges, creates, modifies, forms, positions, randomizes or otherwise contributes in any way to forming a non-homogenous structure that is believed not too easy to replicate without being distinguishable.

Box 220 describes distributing the physical objects and authentication of the characterization information. In some examples, the physical objects can be sold in exchange for value, such as in the way described elsewhere here for transfer between users. That initial value can be the escrowed amount in some examples and/or it can include a fee and/or so-called “seigniorage” initial value.

Box 230 is next the posting of transactions, in some exemplary embodiments, each associated with what may here be called an “object distinguisher” or “distinguisher,” for transfers of value to and from objects. A distinguisher can be any way to identify unique aspects of a series of objects that allows them to at least divided into more than one category; in some examples, the identification is unique and further distinguishing may not then be used. What may here be called “posting,” can refer to whatever digital means of making information mainly public and/or fixed. For instance, including information on a blockchain and/or digitally signing it and distributing it over a peer-to-peer networks are non-limiting examples of posting.

Box 240 shows what may be called here “escrowing” value for respective objects; and what may here be called “cancelling” a corresponding escrow in case of exactly one transfer of a value from an object; and what may here be called “releasing” substantially the escrowed amount to what may here be called the “prevailing” party in case of more than one requested transfer of the same value. Many ways to escrow value are known, such as using a trusted entity, sets of entities, and/or so-called “smart contracts” or other automated means. The decision to cancel an escrow, and return the value escrowed to essentially the party that provided it, is one operation that can be provided by whatever means or method such as those for known escrow techniques. Another operation is releasing of the escrowed value, by whatever means or method, to a party.

Referring now to FIG. 2B, the first four steps, shown in 250, 260, and 270, are mainly as already described, with reference to 210, 220, and 230 as already described with reference to FIG. 2A.

Box 28 is the identifying of parties who issue more than one transfer of the same value from the same object by combining information revealed in the at least two issuances of the same value. A known way to achieve a portion of this uses that published in Advances in Cryptology-CRYPTO′ 88, titled “Untraceable Electronic Cash,” by the present applicant, Amos Fiat, and Moni Naar, pages 319-327, which is included here by reference as if copied here in its entirety. The so-called “challenge” that the payee issues the payor in such protocols and the required response are such that if the payer replies to two different challenges then a secret, such as the payer identity, is revealed. Accordingly, with respect to the present inventive aspect, paying the same value twice would then trigger such a revelation. This can, in some examples, result in what is in effect the release of an escrow amount, as mentioned with reference to box 240 above, as just one example. In other examples, when tied to the identity of a person or another thing the cost to the owner of having the improper paying tied to that thing can, it is believed in at least some examples, be a sufficient deterrent.

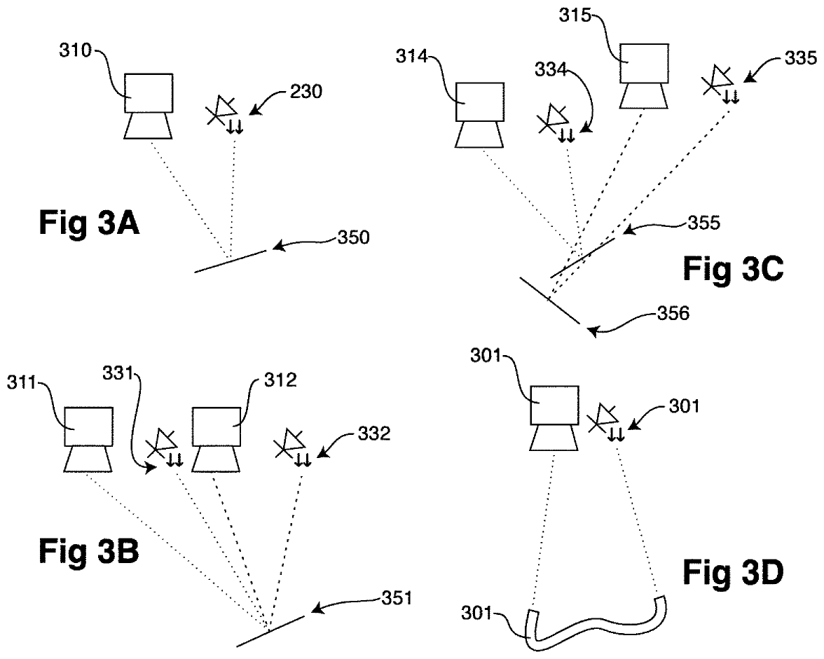

Turning to FIG. 3A-D, detailed combination section and schematic views of exemplary miniature optical element recognition in accordance with the teachings of the present invention will now be described. FIG. 3A includes a reflector; FIG. 3B includes a diffractive reflector; FIG. 3C is an at least partly transmissive first reflector and a second reflector; and FIG. 3D is a waveguide reflector.

When such reflectors or other structures in the mainly or partly or at least somewhat optically transmissive matrix do return optical energy to an illumination and sensor configuration, it is believed that they may create what may here be called “bright spots” or “constellations” that show the spatial and/or angular and/or spectral characteristics of the scattered optical elements. Such bright spots and/or constellations can in some exemplary embodiments be used to recognize the optical elements scattered and matched against stored or otherwise authenticated information to recognize and/or distinguish the object under test in a way that it is sufficiently difficult to what may here be called “counterfeit” or “clone” or “replicate” or “copy” in order to obtain the desired security properties. Referring to FIG. 3A, one or more image capture devices/systems are shown receiving light and/or other wavelengths of the electromagnetic spectrum as mainly at least reflected from reflective miniature optical element 320. Such elements, as will be appreciated, are discussed here individually or in small number but will have been what will be called here “scattered” in large number at least to a certain extent randomly and unpredictably. What is desired to be achieved is the known property that a random dispersement can be extremely difficult to replicate; various schemes have been proposed in the literature and even some evaluation of difficulty proposed, which the present specification includes here by reference.

In one example, the reflector can be that in Aventurine glass: “metallic copper particles [that] precipitate throughout the glass in crystalline structures, which, when viewed under a microscope reveal themselves to be triangular and hexagonal in shape.” The article quoted goes on to state “Under a microscope, the crystals appear to be suspended in a colourless vitreous matrix.” In other examples the reflectors can inclusions in naturally formed Aventurine gems or stone. Artificial and natural formation combined, such as modification or fracturing of natural elements with addition of artificial elements, is also anticipated in whatever combination. In still other non-limiting examples, the reflectors can for instance be glitter or the like scattered in a polymer or other transparent matrix, as is well known, such as even in various commercially available decorative nail formulations.

The setup shown here includes a relatively small source of light 230, shown for clarity but without limitation as an emitting diode. Smartphones such as iPhone 10 made by Apple of Cupertino Calif., have such a light source and the resulting sparkle from Aventurine glass has in experiments conducted by the applicant imaged very clearly by such devices.

Referring next to FIG. 3B, diffractive reflectors 351 reflect different wavelengths at different angles, as indicated by the example where the light of a first wavelength distribution from source 331 returns to detector 311, whereas that representing a second and believed different spectral distribution results from the light supplied by source 332 that is collected by the optics of detector 312. Including such reflectors provides angle sensitivity and also increases the number of types of reflectors and orientations, believed to help increase the difficulty of cloning. Diffractive reflector scatterings in mainly transparent matrices are also, for instance, available in some types of decorative nail polish.

Referring to FIG. 3C, reflectors 355 reflects some wavelengths and transmits some wavelengths that are reflected by reflector 356 and again transmitted, but in the opposite direction, by reflector 355. Accordingly, in the example for clarity, sensor 314 sees energy reflected by reflector 355 from source 334; however, sensor 315 sees the light from source 335 that traveled through 355 (with some walk due to angle and some small change in spectral power) twice and was reflected by 356.

When what may be called a 3D scatter of elements can be detected, it is believed that not only more elements can be seen but that it may become even more difficult to clone such configurations. One type of transmissive reflector is the notch filters made by Everix of Orlando, Fla. These have very narrow FWHM reflectance and are otherwise mainly transmissive, yet the non-deposition production process provides huge cost advantage relative to deposited rugate filters with such characteristics. It will be appreciated that diffractive reflectors can also be transmissive.

Referring lastly to FIG. 3D, a waveguide is used to what may here in some examples be called “reflect” or “redirect” light from a source to a detector. U.S. Pat. No. 7,878,398, titled “Counterfeit and tamper resistant labels with randomly occurring features,” by Chen, et al. This application and its references are hereby incorporated by reference as if copied here in their entirety.

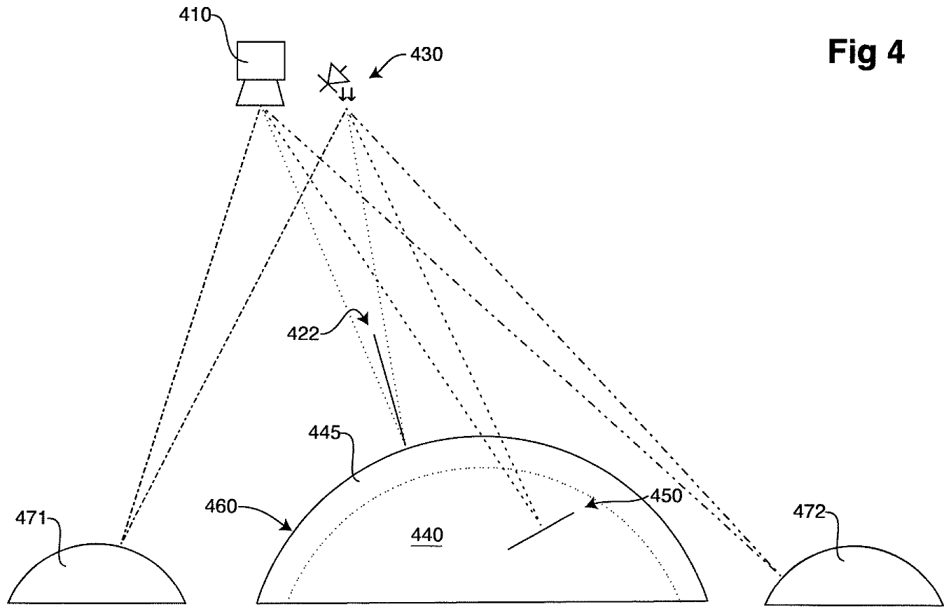

Turning to FIG. 4, detailed combination section and schematic views of exemplary physical arrangement with convex surfaces for detection and recognition in accordance with the teachings of the present invention will now be described. Shown is a convex surface matrix of optical elements and example markers.

Photogrammetry generally can include triangulation to determine orientation of the camera relative to a set of markers, and this orientation is then used in a believed inventive aspect here to direct a search for the reflective characteristics that should be observable from the relative angle.

The curved surface 460 that contains/includes the scattered optical elements in the matrix 440 (and optionally protected by cover 445, such as synthetic sapphire dome or polymer coating) reflects light (dotted line) from source 430 back to camera 410 and when imaged can, it is believed, provide by its location on surface 450 a relatively accurate indication of the bisector angle 422. (An example scattered small reflector 450 in matrix 440 is shown, as will be appreciated, with single-dashed reflected light for clarity.)

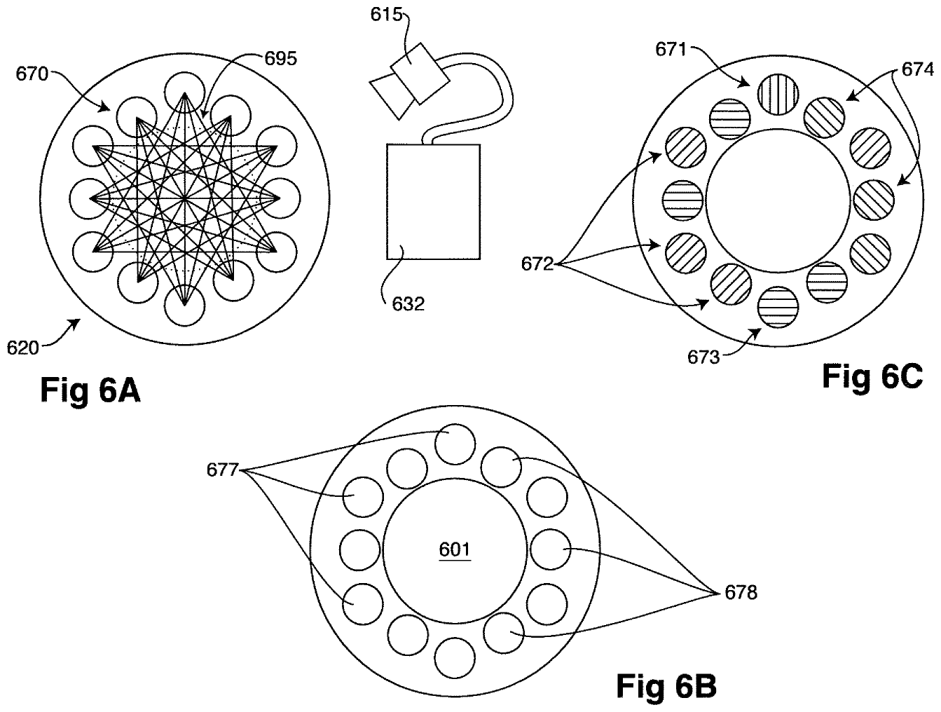

Additional what may here be called “markers” are shown convex curved reflective surfaces positioned fixedly relative to matrix 440 and believed to provide orientation information in by photogrammetry and including by use of so-called “super resolution” of the point of reflection. An arrangement, like that to be described further with reference to FIG. 6, of twelve of such structures has been tested with believed satisfactory results.

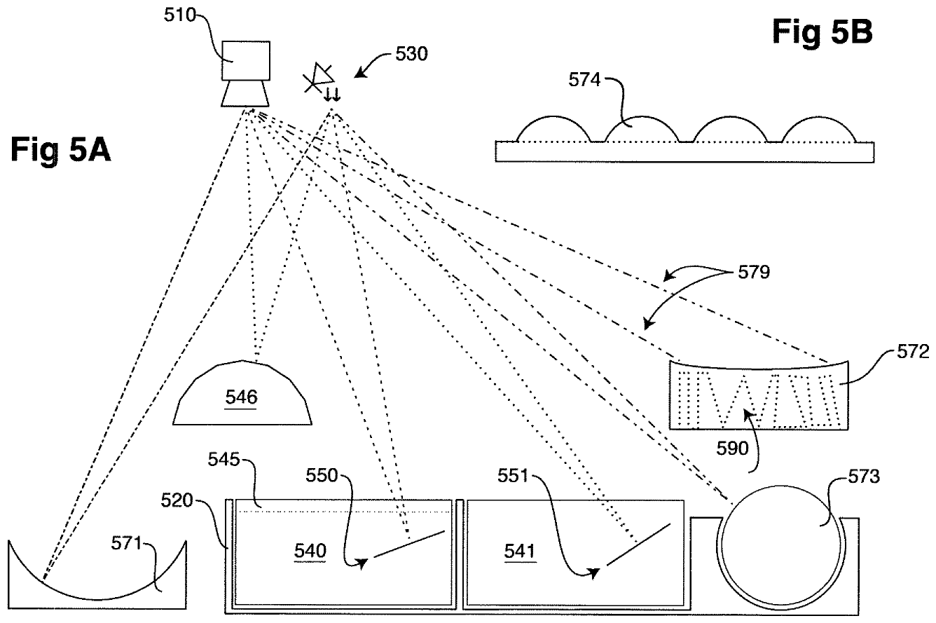

Turning to FIG. 5AB, detailed combination section and schematic views of exemplary physical arrangement including surface regions for detection and recognition in accordance with the teachings of the present invention will now be described. FIG. 5A includes a matrix of optical elements and example markers; FIG. 5B is an array of alignment fiducial elements, any and all of which can be combined in whatever patterns or multiplicity.

Referring now to FIG. 5A, the matrix 540 of scattered optical elements is shown with a mainly flat surface (and including an optional protective covering 545, such as synthetic sapphire or polymer). Some markers 471 are shown concave 571, others convex 573, still others scattering 572, and yet others faceted 546 (believed optionally useful for example: for some angles, like straight on; or to determine approximate angle). In some exam the spheres 573 may be pressed in and/or adhered with cement or retaining compounds, such as urethane methacrylate from Henkel of Germany. Some examples of scattering include colored polymer fill (as will be described in more detail with reference to FIG. 6); other examples include but are not limited to and in combination retroreflective paint or the like, florescent paint, UV and IR characteristics, flat surface, gloss surface, textured surface, patterned by whatever means formed, and so forth. The dot-dot-dash lines 579 are not intended to show reflection of source, but rather the angular range over which the scattering of the surface can be imaged. These embodiments can be combined, as will be understood, to illustrate various exemplary reflective and surface arrangements.

Element 545, can be a quartz, sapphire, hard glass, or the like scratch resistant window. In some embodiments, not shown here for clarity, there may be a window on both sides of an object, such as a coin, and the somewhat transparent matrix in between allowing some light to pass through advantageously. Alternatively, it is believed, a mirror or mirror like, coating, on the bottom surface of a pocket 520 or other cavity, can provide some of the same advantages.

Plural pockets, as exemplified by 540 and 541 for clarity, sometimes referred to as Champlevé, can be filled with whatever matrix and/or for example aventurine glaze (such as that disclosed in: Aventurine “Mechanisms of phase formation of aventurine glaze,” by I. A. Levitskiil, Steklo Keramika, No. 6, pp. 29-32, June, 2001). The pockets can be suitably formed (such as sandblast textured) and/or coated (such as ionic bond and oxide formation, to enhance adherence, as is well known in the dental restoration art). In some examples, durability can be enhanced by such techniques. It is believed that pocket sizes can advantageousness be chosen in various ranges, such as from tens of microns to millimetres. It will be appreciated that a metal of suitable plasticity, including malleability and work hardening, may be desired for die striking coins; however, glazing may require high temperatures that rule out many common alloys. Aluminium bronze, such as with aluminium of 3%, 5%, 7% or more is believed a suitable material.

Structure 590 shown by dotted lines includes various sub-surface structures that can enhance the durability of the polymer. In another example, as will be appreciated but not shown for clarity, are retroreflective micro structures formed in a reflective surface, such as regions of a coin as will be described further with reference to FIG. 6.

Referring to FIG. 5B, an arrangement of mainly spherical domes 574 is shown in section protruding from the object surface. It is believed that five such domes provide enough reflection points to determine an ellipse algorithmically from a captured image and then to determine the angle of retro reflection of reflective elements 550. It is further believed that the center point between the optical center of camera 510 and emitter 530 is in effect the point (apart mainly from occlusion) that can be considered the source and destination of retro-reflection. This then allows, as will be understood, the scale, tilt, and rotational or “clocking” of the object to be determined. (In some examples so-called “stray light” reflections from domes to other domes and the object under test can be reduced and/or obviated by appropriate choice of dome size and distance from, as will be understood.)

As just another one of many non-limiting examples, the ovalicity of the image of circular pattern can be calculated (as is known in eye tracking, for instance) and, along with a reference point it is believed, the angle of measurement can also be calculated. As yet a further illustrative example, a rectangular or other known shape can be used in a similar way to a circle, such as in augmented reality systems. Two parameters, such as tilt and clock angle, for instance, it is believed can be used to consult the stored data to find the so-called “bright points” positions on the surface that are most reflective and to verify any “dark points” positions that are not to be reflective. In some examples, illumination 530 can be varied, such as on and off, for different images by sensor 510 and the reflections from other sources cancelled by digital image processing subtraction as will be understood.

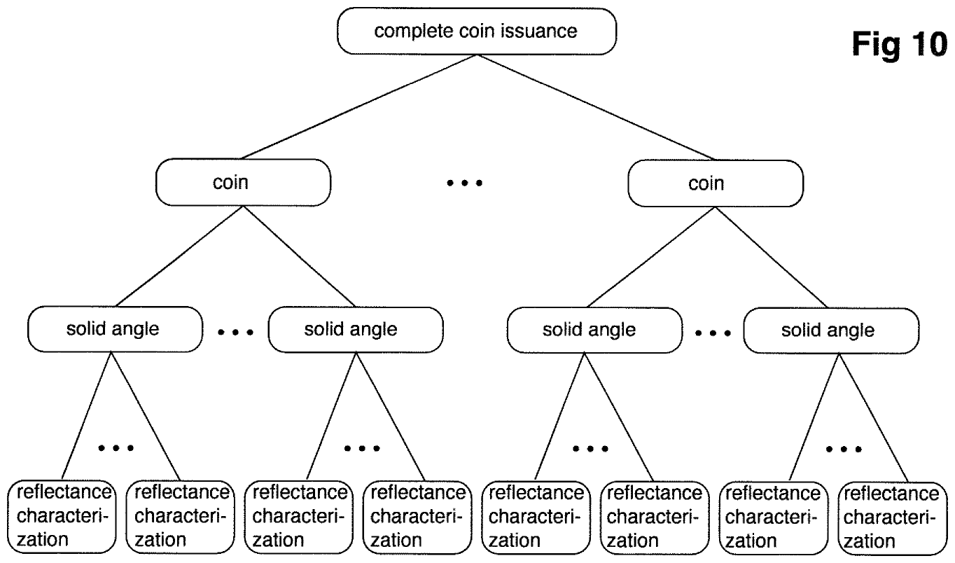

In still other examples, the pattern of as may be used here “bright points,” those of the scattered optical elements that most stand out during a particular viewing angle, can it is believed be used to look up what may here be called “constellations” of such points that have been stored or in the structures such as to be described with reference to FIG. 10. For instance, a hash of such coordinates, normalizing for scale and rotation, it is believed could be used. As will be appreciated, the stored information can be accessed by whatever combination of such techniques and/or additional data or encodings added to facilitate search and/or confirmation.

In a hand held device, such as described already for instance with reference to FIG. 1, real-time calculation of the tilt and clock (or other parameters) can be displayed or made known by audio or haptic or the like to provide feedback to the user to guide the user to a particular angle. One exemplary use is to provide high-res images for certain such angles. Another exemplary use is to allow more than one user to each provide separate illumination and adapt their angles to produce images that may be more difficult to catalog and provide an additional test of actual possession once the particular angles and constellations are revealed from committed form, such as also mentioned with reference to FIG. 10.

In the capture phase, such as after the objects are manufactured, many different angles of illumination should be used and the data recorded, as described variously here. As will be appreciated, an example believed advantageous approach includes a single rotational stage, such as a stepper motor, and an array of light sources (not shown for clarity) arranged more or less parallel to the axis of rotation, along with one or more cameras located along the line (or for instance an arc) of the illumination sources. As will be understood, a single rotational position can be captured for multiple tilt angles by multiple illumination sources in a temporally disjoint sequence.

Turning to FIG. 6A-C, detailed combination section and schematic views of exemplary targets, coding and recognition in accordance with the teachings of the present invention will now be described. FIG. 6A includes synthesized lines between reflection points; FIG. 6B includes arranging regions around a central matrix; and FIG. 6C includes variable coding in a fixed pattern of regions.

Referring now to FIG. 6A, an exemplary coin form factor 620 is shown in plan view with software or otherwise synthesized constructed lines 695 and an inset for a matrix (as already described with reference to FIGS. 4 and 5) of scattered miniature elements in dotted line outline. The lines 695 are between reflection points from convex spherical elements 670 (as also shown and already described further with reference to FIG. 4). When a reflection from a scattered element, or from the surface 460 already described, is identified during photogrammetry (such as using camera 615 and processing means 632), its location can be determined it is believed by such techniques as super resolution of the region produced by direct reflection from a light source. The lines can be constructed based on two points, as will be understood. The choice of lines and the distances from them determine the location on the object, according to Euclidean geometry. The distance from such lines can be calculated using known algorithms, such as for instance as has been easily found in Wikipedia under the topic “distance from a point to a line” and sub-topic “line determined by two points.”

Referring next to FIG. 6B shown is the arrangement, also present in 6A and 6C, of two rings of targets, one ring of smaller diameter 678 with elements staggered between the elements of one ring of larger diameter 678.

Referring next to FIG. 6C, an exemplary pattern of target types is shown. An example function of a target pattern, whether geometric and/or coding, is to allow symmetry disambiguation. Element 671 is unique and can by convention mark the top of the coin in some examples. Another exemplary function is to identify the particular coin and the example shown by using three colors (672, 673, and 674) can it is believed code over one thousand coins; the colored regions can be different colors of polymer or glass formed in place as is known, or insets of different materials, or different diffractive or retroreflective microstructures even patterned in a metal coin, etc.

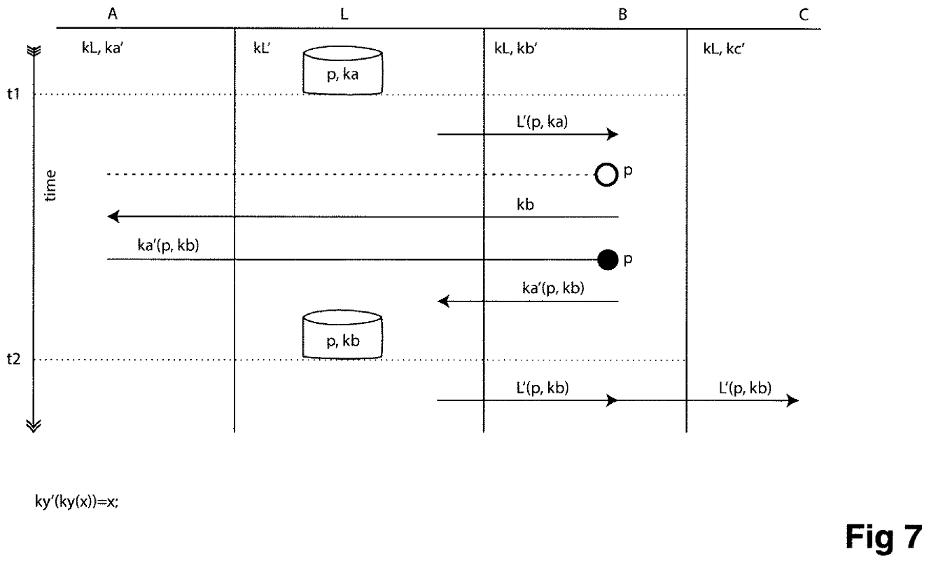

Turning to FIG. 7, a detailed combination cryptographic protocol and physical process diagram of an exemplary transfer of value accompanied object received once in accordance with the teachings of the present invention will now be described. The diagram shows time descending along the vertical; the four actors across the top “A” (mnemonic: Alice), “L” (ledger), “B” (Bob), and “C” (Charlie); the protocol assets in the columns; punctuation of time by dotted horizontal lines; the communication informational and/or physical as horizontal arrows of various types; and a single value of payments is implicit and not shown for clarity.

Initially, the protocol assets are keys, public and private: A has the public key of L, shown as kL, along with A's own private key ka′; L has kL′ the private key it can use to sign messages as well (as the ledger shown for clarity with only the single entry p,ka); B has the public key of L and its own private key kb′; and C also has the private key of L and a private key of its own not used but shown for completeness. The physical object is denoted p. (As a mnemonic for the public key cryptographic notation adopted for clarity here, ky′/(ky(x))=x appears at the bottom of the figure and is intended to suggest that in the notation each signing party y has two functions ky′ and ky and that are inverses of each other.)

Before or at time t1, L includes the ledger entry shown in the typical database graphic, indicating that physical coin p has been taken ownership of undisputedly by the owner of the private key corresponding to the public key value ka. After time t1, party B obtains authenticated information about this entry L′(p,ka), such as part of a routine download/update, from A, or from another party. Also shown is the what may here be called “revocable” transfer of the physical object p from A directly to B (not involving L even though lines in the notation cross over L's column), shown with what may here be called the “hollow-circle” arrowhead. Such revocable transfer suggests the tentative nature of the unconsummated transaction: intuitively and for clarity for instance it is believed that B is not sure that the value will be obtained and/or A is not sure that it will be accepted. In some examples this can be by transfer of information only; however, it is anticipated that it may be preferable in at least some exemplary embodiment instances to physically put the physical object p “on the table” or otherwise make it available for inspection by B while still allowing A to regain possession if the transaction does not complete.

At this point B knows p preferably is in its physical presence or even possession and so can provide the custody public key kb (corresponding to the private key kb′ that B has chosen unpredictably). Intuitively B can be thought of as saying to A in effect “OK, if I can keep the physical p that is on the table and you sign its control over to the public key value kb that I sent you, then the transaction is final.” In some examples the physical object can be self-identifying, in that information sufficient to readily match the corresponding ledger entries can be readily obtained from its structure (such as by marking and/or internal electronics, as mentioned earlier); however, in other exemplary embodiments, such linking will be facilitated by information otherwise provided by A to B, such as smartphone to smartphone as already shown and mentioned in FIG. 1. Accordingly, this step can it is believed for clarity as will be appreciated be thought of as including up to at least three aspects: a physical putting on the table; an informational linking; and verification of physical presence and/or authenticity.

In order to consummate, A provides the transfer of control signature: ka′(p,kb), as described and will be understood. Additionally, and what it is believed advantageously can be essentially simultaneously, A relinquishes the revocability of the physical transfer, as indicated by the what may here be called “filled-circle” arrowhead. Examples can include, without limitation, it is believed for clarity as will be appreciated, can be thought of as allowing B to take the object from A's hand or from the table or A simply giving B the object that ideally was in view but out of B's reach. The signature can be provided for instance at essentially the same time, such as for instance by radio frequency, infrared, optical scanning by B of a barcode displayed by A, or the like.

Now, it is believed that it can be in B's interest to facilitate recordation of the transaction by L so that the value can be available to B in future. To this end, B is shown providing to L the signature ka′(p,kb), as already described when it was received by B from A. The ledger is now updated by L with the now latest valid entry, replacing the previously described entry, shown as p,kb. In some examples, as will be understood, the history of ledger updates as well as the signatures underlying them may also be variously corroborated, audited, validated, archived, and so forth, as is known or will be understood. Once time t2 has occurred, as illustrated by vertical position below the second horizontal dotted line, the configuration of the system is much as it was at time t1. Accordingly, another transaction can proceed in the same way as that already just described in detail. To show a first aspect of this for clarity, as will be appreciated, the party C is shown obtaining the initial ledger entry much as 13 had obtained the corresponding entry earlier. In particular, this new entry, signed by L, is of the form L′(p, kb).

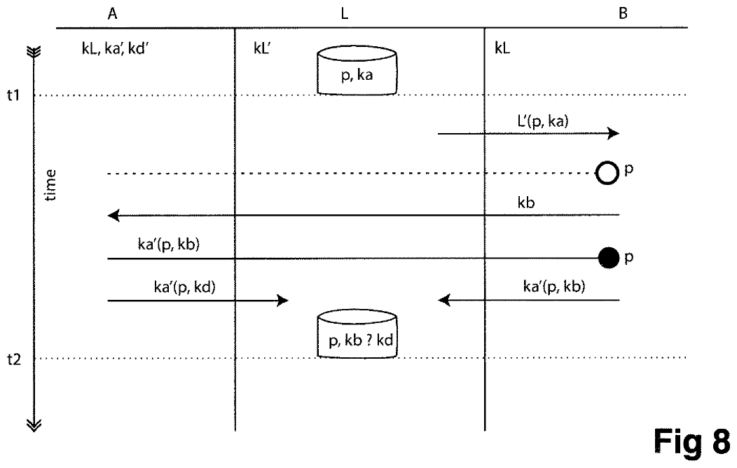

Turning to FIG. 8, a detailed combination cryptographic protocol and physical process diagram of an exemplary transfer of value accompanied object received once in accordance with the teachings of the present invention will now be described. The diagram is similar to that already described in detail with reference to FIG. 7, though party C is omitted for clarity and an additional, what may here be called “fake transfer” or “fake transaction” has been reported.

The operational aspect of the diagram differs from that of FIG. 7 it is believed beginning only after the solid-circle arrowhead transfer of p by A to B. Unlike the single transfer transaction of FIG. 7, here at least two different transactions are reported for the same physical object p and both as the immediate successors to p,ka. At least one of the transactions will be considered a fake transaction for clarity, as both or more cannot be consummated for the full value, since in the example the value (which is implicit for clarity in description, as mentioned and as will be appreciated) is for a single transaction.

Accordingly, a dispute is recorded by L, shown in the diagram as: p, kb ? Kd. The question mark “?” between what would have been the entry following the comma is intended to suggest that there are in the non-limiting example two (for concreteness and clarity) different transactions submitted. Only one submission is not a fake transaction and only one transaction (and ideally that non-fake transaction and presumably its corresponding party) should receive the value.

The notion that electronic money can fork into more than one instance and it may be needed to stop one or more of the instances and reward one instance has been dubbed by the present applicant as “the double spending problem” from an early point in work on electronic payments dating back to the early 1980's. A number and variety of means and methods can here provide aspects aimed at resolving such situations:

One example non-limiting example is the use of the “untraceable electronic cash” cryptographic protocols referenced earlier here, where the party, A in this case, issuing more than one signature, on kb and kd in this ease, as a consequence has revealed an otherwise secret identity used to establish use of the system earlier. The result is that the user may be excluded from further use of the system and/or sacrifice escrowed or upside value and/or receive other disadvantages or penalties.

A second non-limiting example resolution includes one of the parties may what may be called “concede” and form a signature asking for the dispute to be resolved in favor of one or more other parties.

Yet a third non-limiting example resolution includes a further what may here be called “double down” placed by one of the parties and requires that the other party or parties reciprocate with similar extra liquid asset collateral or other stakes. If reciprocation is not provided in a timely manner, at least some of the contestants can be disqualified.

Still another non-limiting example resolution includes what may here be called a “physical resolution” time when physical coins are shown to and/or obtained and/or destroyed by one or more designated parties and/or in effect by the public.

Yet still another non-limiting example includes one or more juries or the like, whether composed of people and or algorithms, deciding which transactions are fake. If a series of uses results that shows depth of liquidity that would make the fake transaction unprofitable, then the decision can be in favor of such a fork.

Yet again even another non-limiting example resolution has a low probability of occurring but high cost to the issuer of fake transactions. For instance, certain physical coins can in a way that is ideally not manipulatable by any party be randomly recalled. If they are turned in there can be a reward. If they resolve a fake submission, then heavy penalties can be applied.

Once there is a resolution: both the value can be provided to the prevailing party; and also, whatever escrow can be released to the prevailing party (incentive fees may be levied by various parties, such as juries or verifiers mentioned earlier). As a consequence, it is believed that the party initiating the fake transaction(s) will lose value and possibly other valuable consideration to the correctly performing party(s) with at least a probability and the party initiating the fake transactions was not initially incentivized to create the fake transactions and accordingly it may have been an irrational act and not anticipated to occur with high frequency.

Also, since the transaction value (in the examples simplified for clarity as implicitly of a single denomination) can in some exemplary embodiments be released only if there is resolution, in some sense what may be thought of as the system itself does not have to have the liquidity to resolve disputes. Other parties, however, can resolve the disputes early and make funding available to victims—especially once such other parties have seen the physical object in possession of a party—and thereby also position themselves to make fees from the party issuing the fake(s).

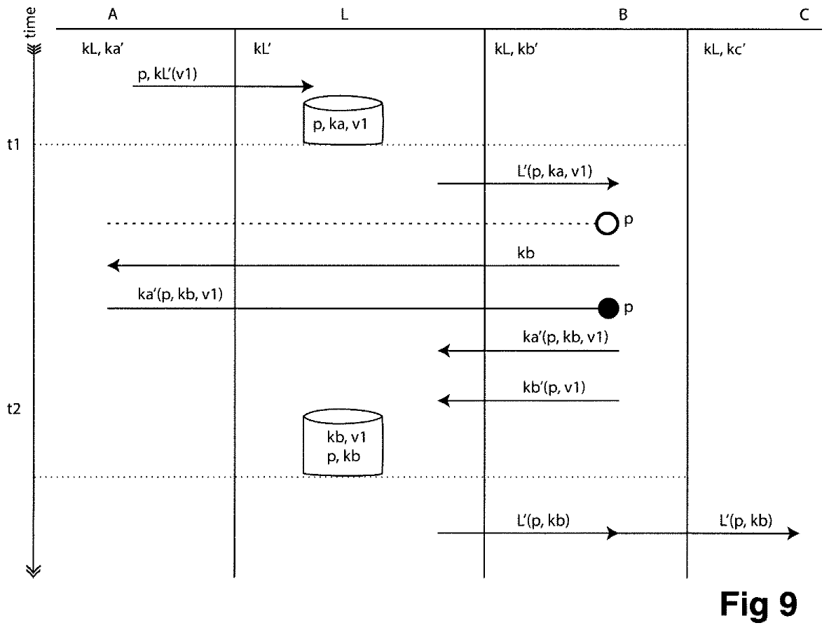

Turning now to FIG. 9, a detailed combination cryptographic protocol and physical process diagram of an exemplary addition of value and subtraction of value for a received-once value-accompanied-object in accordance with the teachings of the present invention will now be described. The diagram is similar to that already described in detail with reference to FIG. 7, however, here value is added by A and then subtracted by B before being transferred to C.

The first arrow shows A adding value v1 top by sending a signature for the value to L. In the example, the signature was made by L and does not include p; however, it could be made by one or more other parties, as will be understood, and can include some function of p so as to avoid double spending issues, all as will be readily understood here. The ledger L then shows this value addition in its database at the close of the period ending with the first horizontal dotted line.

When B receives the second message shown, L′(p,ka,v1), B learns that p has had value v1 added to it. Later, when B reports to L the value received from A, as in FIG. 7, included is v1. Then, to illustrate subtraction of value, B is shown sending in a signed request to subtract v1 from the object p and to simply have it stored in account under custody of B's own private key: kb′(p, v1). This is then shown as recorded by the first line displayed in L's ledger. Finally, when B and C learn what is associated with p, value v1 is not included.

Turning to FIG. 10, a detailed combination cryptographic and data structure in accordance with the teachings of the present invention will now be described in detail. The diagram shows a four-level Merkle tree for the data related to a set of objects.

Referring to the diagram, each level contains the hash of all its direct descendants, the nodes directly below it in the hierarchy. Accordingly, the reflectance characteristics of a particular small optical element that has been included among those scattered and that formed the first coin in the set is shown on the lower left of the diagram and is one of several that appear when viewed (and/or illuminated) over a particular solid angle range (shown as its parent directly above it). Each coin, the next level second up, then has characterizations at each of multiple solid angles as its descendent subtrees. A fixed number of coins, the cardinality of the second level, make up the “complete coin issuance,” a system that caps the total number of coins to be issued at least in the series.

When the coins are scanned at fabrication time each reflectance characterization (optionally along with some fake characterizations, described further below) are grouped into what will here be called “solid angles”. Such solid angles can abut or overlap (with duplicate characterizations allowed) or have gaps between them; they can be the same across coins or differ per coin; they can for instance be tetrahedra or pyramids or of whatever angular range defined by regions of whatever shape on the object as seen from the camera, at least to first order of approximation. The set of solid angles then makes up the coin subtree and it is hashed to form the respective entries at the coin level. These coin level entries or subtrees are then hashed to form the complete coin issuance root, which is ideally authenticated by one or more means or methods.

When a physical coin is to be authenticated, one or more images are captured. The solid angle can be determined for at least some of the images and then the reflectance characterizations. These can then be searched for matches with the tree data, which can readily be authenticated, as will be understood, whether provided for instance by the payer or obtained in advance by the payor, or some combination. Fake inclusions can encode information available only to those who can make a complete enough scan (which it is believed may be hard to do without taking too much time and/or using special fixtures/jigs). Such encoded information can include secret keys or key material and/or self-authenticating information such as signatures or MAC's.

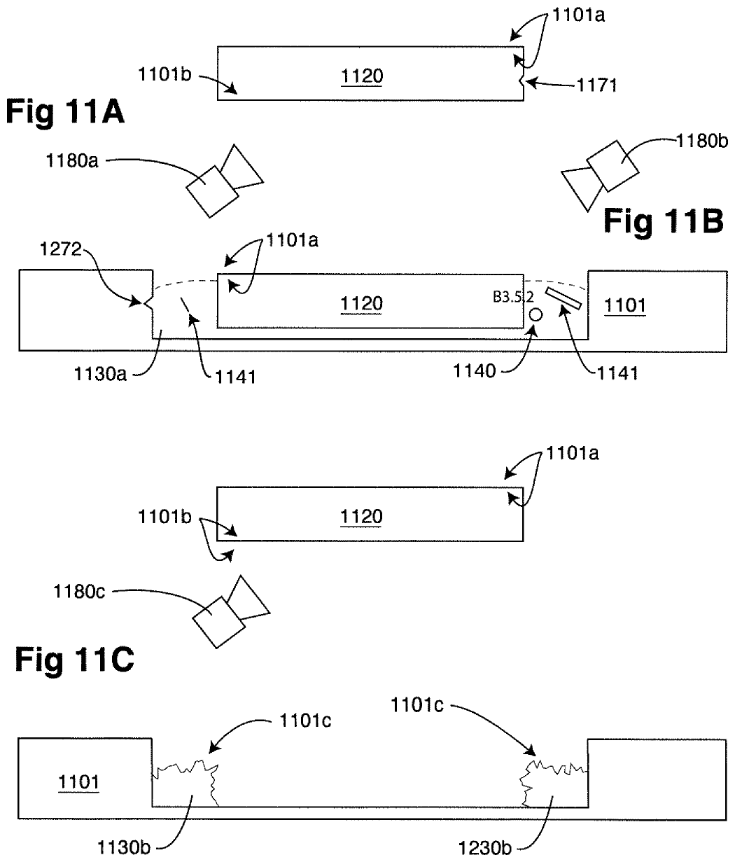

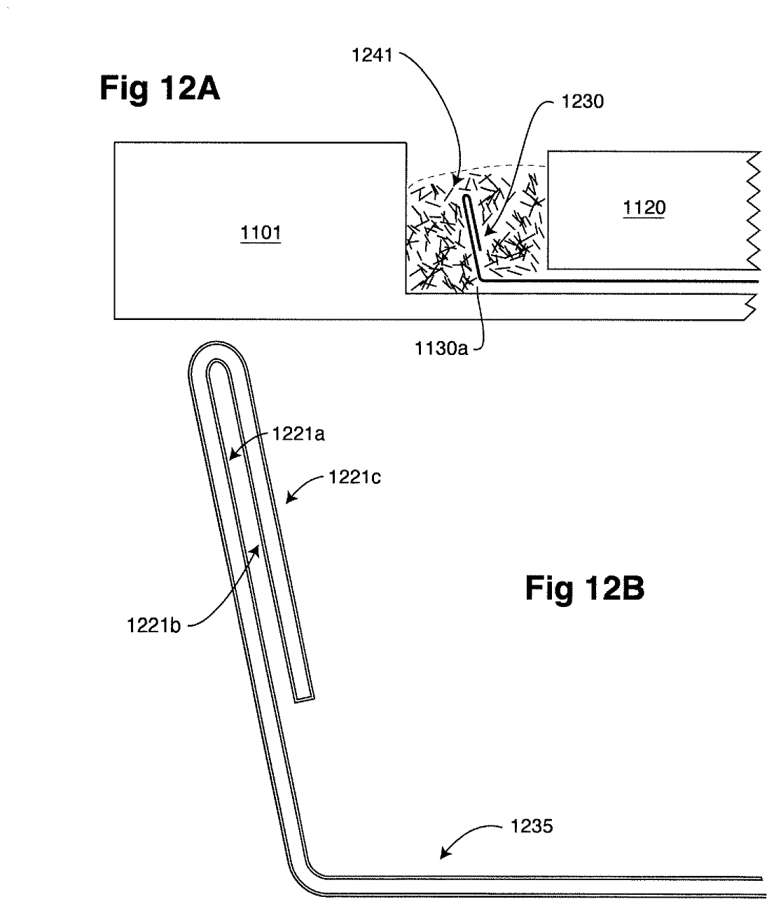

In some examples the tree or other published commitments can include information that is what may here be called “held back” initially and is only revealed later, in case of disputes and/or to retire an object. The hash image or other one-way function image or the like can be authenticated in the tree, but the underlying information held back until a time where it may optionally be revealed as committed at time of tree formation. Some such information, called here “secret,” will be described additionally with reference to FIGS. 11 and 12. Some such held back images can be related to information hidden in the object, as described in some examples with reference to FIG. 11 and FIG. 12. Other held back information can be from capture that is chosen from a larger space of possible captures, such as illumination from more than one specific angle, the example already mentioned with reference to FIG. 5.

In some examples, cryptographic protocols and/or techniques can be used to secure and/or make more robust the held-back information authentication. For instance, but without limitation, portions of such information can be so-called secret-shared among a set of parties. In other examples, the held back information can be divided into parts that each can be checked with a limited level of validation and each such part provided through a separate means, such as a separate party and/or secret hidden in the object. In still other examples, a so-called multiparty protocol can allow secrets from the object and/or missing or extra included bright points, for instance, to be used to re-construct information that can be physically verified from scanning the object. All of these various techniques can, it is believed, be applied in combination and/or iteratively, as will be understood.

Turning now to FIG. 11A-C, a combination schematic and section view of some exemplary combined object and matrix embodiments in accordance with the teachings of the present invention will now be presented. FIG. 11A is the capture of the bottom of object; FIG. 11B is the forming and capture of the top of the object and the matrix; and FIG. 11C is the re-capture of the bottom of the object along with the resulting damage to the matrix.

Referring now to FIG. 11A, the exemplary aventurine or other optical element matrix object 1120 is shown in section with the lower surface 1101b sensed by capture means 1180a, with light sources omitted for clarity.

Indent 1171 exemplifies shapes and/or textures intended to make removal of the object without damage to the matrix 1101 (to be described) more difficult; indent 1272 indicates a similar range of structures and surface treatments for similar purposes.

Referring to FIG. 11B, shown are mainly transparent resin, such as epoxy and/or polyurethane with top coat such as scratch-resistant polyurethane. in matrix are some exemplary element: 1141 is a glitter, but may also contain secret information in a folded and/or laminated form; spheroid 1140 can include a secret color or range of colored tangents, optionally with a color or placement on the outside for ease in manufacture and checking during use; and package 1141, much like the folded foils of to be described with reference to FIG. 12, is shown untethered in this exemplary embodiment.

In some examples, 1141 is an electronic circuity, such as in any combination a micro controller, dedicated logic, transceiver, memory, accelerometer, microphone, speaker, camera, light emitter, power generator, power receiver coil, security fuses, and the like; exemplary functions include, identification, cryptographic operations and protocols, storage, and the like. The top of the coin or other what may generally here be called “carrier of value” shown is sensed by capture means 1180a, with light sources again omitted for clarity.

Referring finally to FIG. 11C, shown is the extracted object, 1120, being sensed from the bottom side 1101b by capture means 1180c, with light sources omitted for clarity. Also shown is the rest of the structure 1101 with the object removed. The damage or visible alteration to the matrix material 1130a described with reference to FIG. 11A is shown altered by jagged lines, including the altered surface, now in altered form 11101c.

In some examples so-called “scratch off” may be used to provide a kind of irreversible or recognizable access to additional information. This can, for instance be in addition to or replace that described already here. The scratch off structure can be attached to in whatever way the object, stored within the object, protected by whatever structure, and/or be transferred separately.

In operation, as will be appreciated, the object underside is optically captured, the object is then embedded in the matrix along with various other optical elements, some of which may encode secret information in a hidden form. The assembled system, such as in the form factor of a coin, is itself captured, including the object and the elements in the matrix. Later, in the eventual optional case that the secrets are to be recovered, such as to resolve ownership of the object and/or to stop its use so that value can be transferred from it, the secret information can be made public. However, the previously recorded secrets, from 11A are in some examples kept secret but committed to such as by the publication of so-called one-way functions or hash functions or whatever cryptographic commitment to the value. This then, in turn, allows what is published to be validates and/or corroborated, such ab by those involved in the process of FIG. 11A.

Turning to FIG. 12AB, a combination schematic and section view of an exemplary matrix containing a secret in folded structure embodiments in accordance with the teachings of the present invention will now be presented. FIG. 12A is a close-up detail of a portion of the object; FIG. 12B is folded structure in further enlarged section view.

Referring to FIG. 12A, the structure already described with reference to FIG. 11A, such as what can be the outer rim 1101 of a coin or other physical embodiment and the aventurine or other structure(s) 1120 shown for clarity as a single rectangle. Additionally, for illustrative purposes, as will be appreciated, some exemplary what may be glitter or the like 1241 is shown in matrix 1130a. The folded structure 1230, to be described in more detail with reference to FIG. 12B, can be seen in profile.

Referring to FIG. 12B, the enlarged folded structure 1235 is shown in profile. In some exemplary embodiments it can be formed from a patterned metallized foil or the like, with pattern at least on the outer surface 1221c that can be seen by sensors, such as cameras and illumination, in use but not shown here for clarity. The inner cavity between folded surfaces 1221a and 1221b, can in some examples be adhere together. For instance, an adhesive and/or potting material with a higher melting point and less susceptible to various solvents at various temperatures, as will be understood, is believed advantageously employed. If the matrix is heated and/or solvents applied, the fold would ideally remain closed until the matrix is significantly altered, as already mentioned with reference to FIG. 11C.

Secret indicia, such as applied by solvent and/or heat resistant ink, such as so-called UV curable inkjet ink, such as free radical or cationic, can be applied for instance in barcode form. Stripes oriented mainly radially with respect to a round object can be seen on the surface 1235 during sensing of the optical element. Stripes oriented, for instance, circumferentially, can be hidden on inner surfaces 1221a and 1221b. It is believed advantageous that these can be printed on the same surface side before folding, so as to avoid errors in pairing the secret and non-secret portions.

In some examples, structure 1235 can pass fully under element 1120 and appear at various “clock” positions around an element 1120. Furthermore, the single structure can be oriented, for instance, by being affixed to the bottom of element 1101 and/or by fingers (not shown for clarity) held by tolerances within the pocket in 1101. Moreover, forming such a structure can be, as will be understood and appreciated, be by what may be referred to as “progressive dies,” such as are more often used to foal), larger and more rigid structures, for instance: one pair of dies forms the folded tabs up at ninety degrees; the next folds the flaps down flat; and a third pair tips the folded pedals up, ready to be included.

The outer surface, 1221c is, as has been mentioned, ideally as it can be sensed is reflective and varied in its appearance, such as with colorants and diffractive structures and patterning, facilitation recognition and making duplication the more difficult. The roughly-speaking random spatial and orientation selection of the portion of a larger and varied pattern for the folded part 1235 can increase the difficulty of replication of sensed images.

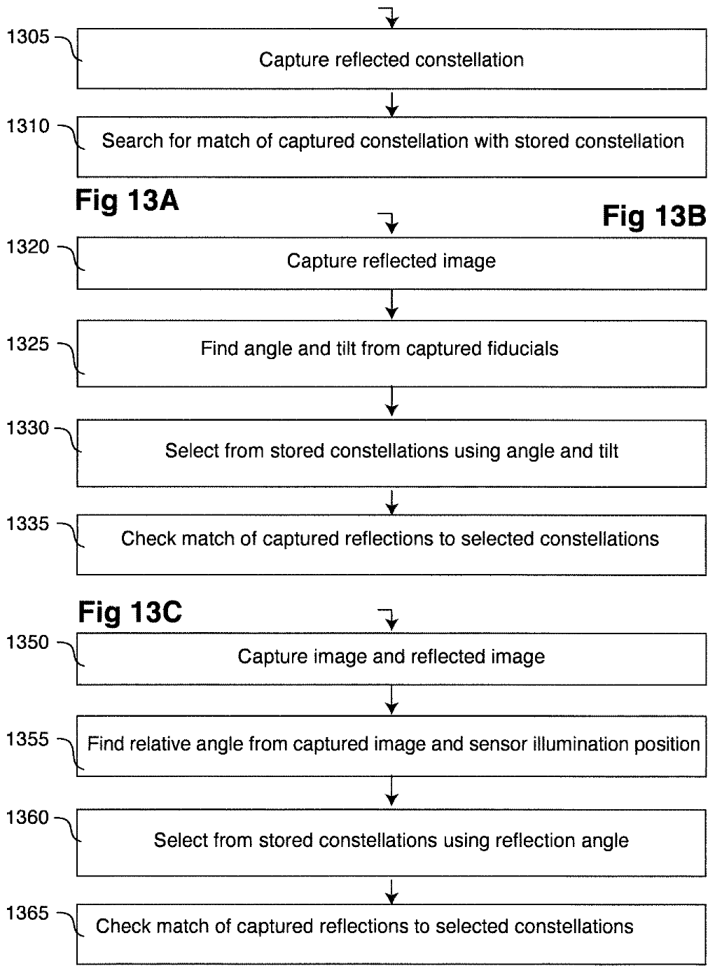

Turning to FIG. 13A-C, flowcharts for systems to validate authenticated objects comprised of dispersed reflective optical elements are described in accordance with the teachings of the present inventions.

For clarity, as will be appreciated, some terminology is believed potentially helpful. What may here be called the “constellation” is the collection of reflections from a set of scattered optical elements related to a single angle and/or small range of angles and/or including information characterizing the reflections, such as including but not limited to: intensity, spectral distribution, angle deviation to maximum, polarization, occlusion from other optical elements.

What may here be called the “reflected constellation” is an image comprised of reflections that make up a constellation, or approximately one or more adjacent and/or composite constellations, such as those related to description with reference to FIG. 3, FIG. 4, and FIG. 5.

What may here be called a “reflection” or the “reflected image” is the image from a sensor that is enhanced, by whatever means, such as including but not limited to combining information from one image where an illumination source is turned on and a t least a second image from at least nearly the same angle where that source is turned off and/or using spectral distribution to separate reflections from certain materials anticipated from other light gathered from the scene.

What may here be called the “fiducials” are any physical structure that is imaged in sensing an object under test, including but not limited to, special features embossed in a metal object for this purpose, such as for instance domes, rings, lines, and the like, and/or boundaries between materials, such as between an aventurine region and/or a metal region and/or a matrix for inclusion of dispersed optical elements.

What may here be called the “stored constellation” is information, however or whether stored, coded, transmitted, calculated, compressed, authenticated and/or encrypted, allowing the reconstruction of and/or checking of constellation capture information, such as including but not limited to coordinates of bright points and/or coordinates of dark points and/or intensity, spectral distribution, angle deviation to maximum, polarization, occlusion from other optical elements. This information is related to the dispersed optical elements, such as described for instance with reference t the structure described with reference to FIG. 10.

What may here be called “reflection angle” and/or “relative angle from captured image and sensor illumination position” is the two degrees of freedom angle between the object under test and the point midway between the optical center of the image capture system and the center of the illumination point. In some examples the center point may be adjusted according to the device characteristics and/or adjusted based on calibration related to information captured from time to time, as will be understood.

Referring to FIG. 13A, the first box 1305 shows the capture, such as by a mobile device as described with reference to FIG. 1, of a reflected image, such as by using at least one illumination source and at least one camera portion of such device, to sense and then identify one or more regions on the image that can be considered to relate to particular dispersed optical elements. In some examples, the illumination is blinked and/or modulated to assist in differentiation of reflections from other light.

Box 1310 next shows that a search algorithm, such as of the so-called “content addressing” type, is used to find a match with stored constellation, such as described with reference to FIG. 10. If a match is found, the object authentication is favored. Adaptive algorithms are anticipated.

Referring next to FIG. 13B, box 1320 shows the digital capture of at least one optical image ideally enhanced to highlight reflections.

Box 1325 describes how the reflected image can be used to calculate angle and tilt and/or other parameters characterizing the relative orientation of image and constellations or structure associated with constellations. In some examples, this can for instance be done using known algorithms, such as those for identifying an ellipse from five points and/or for assigning an ellipse to an image that includes a circular portion, as already mentioned along with other examples elsewhere here.

Box 1330 is the look up of the constellation data that should be associated with a particular tilt angle and clock angle of the object under test, or another isomorphic and/or sufficient set of parameters.

Box 1335 is the comparison, validation, or characterization of degree of fit, of the constellation captured and the constellation stored, such as already mentioned with reference to FIG. 10. Adaptive algorithms are anticipated.

Referring finally to FIG. 13C, box 1350 shows the digital capture of at least one optical image and a reflected image.

Box 1355 calculates the angle deviation between the two and the reflection angle.

Box 1360 is a matching of proximity to stored data described with reference to FIG. 10, using the reflection angle as search keys for initial match constellations.

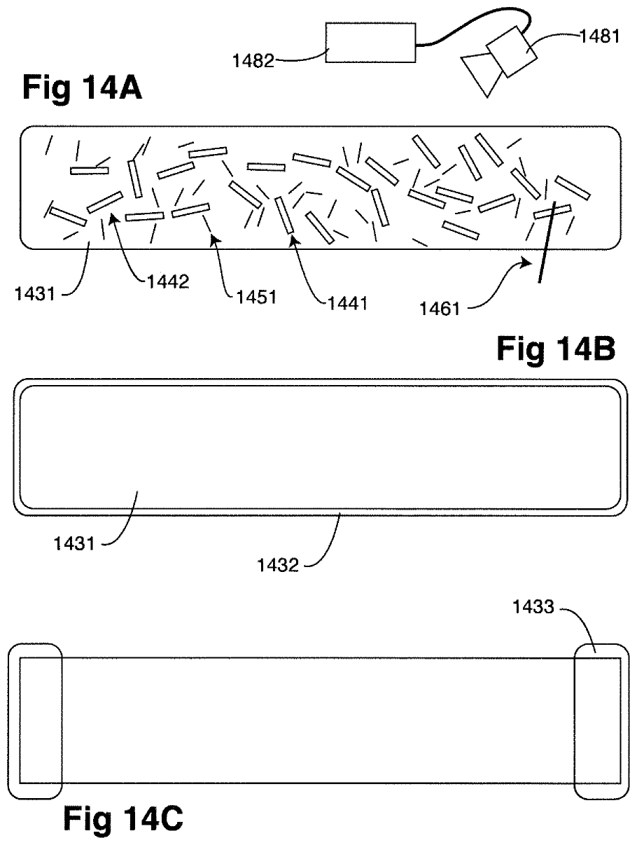

Turning now to FIG. 14A-C, combination schematic and section views of an exemplary scattered precious metal embodiment in accordance with teachings of the present invention. FIG. 14A shows a section with elements and optical and digital means; FIG. 14B shows an exemplary clear coated embodiment; and FIG. 14C shows exemplary protective structure.

Referring first to FIG. 14A, what may here be called “combined digital and optical means” is shown as computer 1482, such as a mobile phone, and camera 1481, such as a camera for imaging and digitizing reflection, refraction and/or alignment pixel information, such as integrated within a mobile phone, and memory means for storing authenticating information.

Matrix 1431, at least partially transparent to light, such as for instance injection molded and/or cast polymer, such as polycarbonate or acrylic, is shown in section.

Embedded in the matrix are what may here be called “elements” 1441 of what may be called here “precious metal,” such as for instance gold or platinum or the like. What will here be called the “surface” 1442 of such elements, for instance a reflective flat and/or curved and/or textured interface may in some examples include colorants and/or diffractive structures embossed on it, such as are used in gold coins issued by the Canadian mint. The surface may be formed or otherwise realized to provide unique and/or difficult to replicate optical properties.

Penetration 1462, what may here be called a “small penetration” can for instance be a drill hole, laser hole, water-jet hole, or the like; also what may here be called “assay” is any means or method for assessing the precious metal in elements 1441.

What may be called here “additional optical elements randomly positioned in the matrix” 1451 are any and all optical element types described and/or anticipated elsewhere here, such as glitter.

Referring to FIG. 14B, a what may here be called “transparent and protective layer formed over at least a portion of the substantially transparent matrix” 1432 is shown in the exemplary section around matrix 1431. In some examples the layer can be a coating, dip, over mold, separately formed material combined with or without adhesive, as just some examples. It is believed that such a layer can advantageously keep the precious metal portions away from the surface of matrix 1431 and/or provide scratch and/or wear resistance. In one example, matrix 1431 is molded by a robot filling the open mold with a measured amount of precious metal flakes 1441 (as well as optionally glitter 1451) and then the mold is closed and matrix injected; after this, the overmolding takes place as is known.

Referring finally to FIG. 14C, over molded elastomer 1433 is additional formed to protect the matrix 1431 and/or to provide recognizable form and/or handling by users.

Various terms and phrases can be used here with special meanings, some examples of which will now be described collected together here for clarity.

What may here be called a “value transfer system” is any kind of means or method or combination that transfers value from one party to a second party, such as a payment system of a system the transfers some other kind of token or the like.

What may here be called a “physical token” is any physical object, such as an article of manufacture or the like that can hold value so that when it is transferred physically the value it holds is transferred. In some examples, the value results from indicia or structure in the object, not the object itself.

What may here be called “indicia hiding means” that may be said here to “hide” the indicia, at least approximately and at least against some sorts of attacks.

What may here be called “removable hiding means” is any kind of structure, such as scratch-off and/or pull-tab, for instance, that hides indicia or other structure until it what here may be called “removed.” A hiding means that may or may not be removable can here be referred to simply as a “hiding means.” What can be referred to here as “indicia hiding means” is hiding means with the effect of, but not limited to, hiding of indicia information from view.

What may here be called “once-removable” is any physical structure that can be removed once but that resists re-application in the sense that this is readily recognized, such as with scratch-off latex; what may here be called “removal of the hiding” is the removing of such physical structure.

When physical structure is removed so as to reveal indicia or other structure it may here be said that this is done “in view of the second party” or “viewable by the second party” to indicate that the second party has been given some level of confidence at least that the once-removable structure was removed in front of the second party. As one example, the second party can remove the structure himself or herself; as another example, the second party can watch as the first party removes the structure.

What may here be called “separable portion” is any physical arrangement, structure, or article of manufacture that allows a person with or without special tools to remove that portion from the whole. All manner of examples are anticipated, including frangible, break-away, perforations, bend fatigue, and any other means or method or way to allow a part to be separated. Other examples, without limitation include: frangible molding, perforated separation lines, adhesive holding, bending fatigue breakable, and interlocked separate structures.

What may here be called “transfer of the separated portion” can for instance refer to the taking of a portion of a token or other physical device or structure by a second party that is allowed and/or facilitated and/or effected by another party.

What may here be called “face value” is the value corresponding to indicia, such as in a national currency, tokens, and/or points or whatever other units.

What may here be called “unpredictable” is also sometimes referred to here as “random” and is something that is at least not known to or easily with high probability guessable by at least some parties. For instance, as just some examples, included are the outcome of an experiment, such as flipping a coin, or the creation using a photographic system of a signature on a public value.

What may here be called a “provenience signature ensemble” is a public key digital signature made by the holder of a token, such that the signature can be verified as related to or signed by a chain of signatures that traces back to that of the issuer. In some examples, such an ensemble can, in some non-limiting examples, include a series of signatures that show the history of use or spending of a token. In other examples, the signature can include a public key of a party that value has been transferred to; one advantage of such an arrangement is believed to be that the party to whom value has been transferred can sign to transfer it on to another account or party; another advantage is believed to be that the party has evidence that they should be the recipient and not any other party. In the case of what may here be called “forked transactions,” the provenience signature transfers ownership of the same value and/or indicia to more than one party, which is improper.

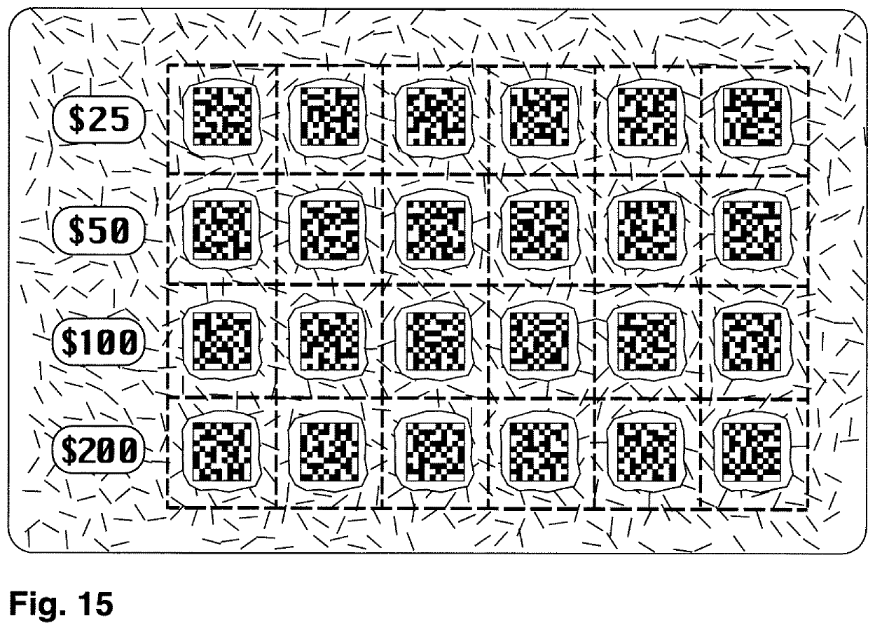

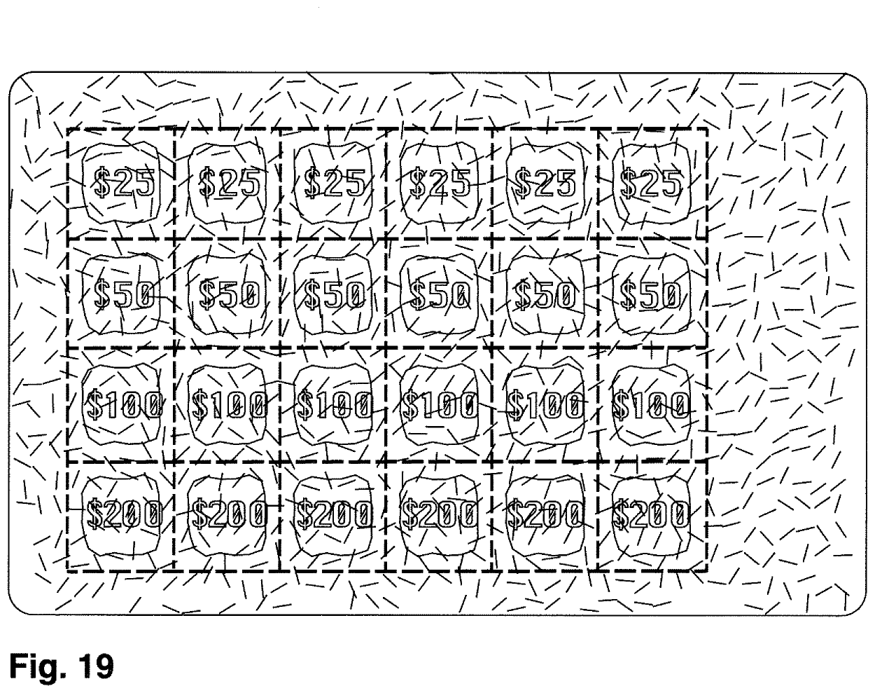

Turning now to FIG. 15, an exemplary multi-position random element structure is shown transparently in combination plan and schematic view in accordance with aspects of the teachings of the present invention. The example is shown for concreteness in the form factor of a card, but without limitation, and includes random optical elements and scratch-off covering shown transparent for clarity in this figure; there is at least one indicia portion and optionally at least one frangible element and at least some of the frangible elements include a respective indicia portion. (Optional indicia present on the reverse side as will be described with reference to FIG. 19 is not shown here for clarity.)

In the example the substrate is shown including representation of a large number of relatively unpredictable elements with optical properties. For instance, as just one example, an at least partly transparent credit-card sized form factor with glitter and/or other optical elements dispersed. Other examples include aspects described elsewhere here.

The thick dashed lines indicate frangible structure, such as but without limitation, for instance perforations that have been laser-cut and/or die-cut and/or molded-in, as an example way of allowing the various regions to be removed by one or more persons with or without special tools.

The example denominations are listed on the left, as will be understood to apply horizontally. These denominations are just examples and whatever denominations and/or currencies and/or units of whatever type are anticipated. The labeling indicia can, in other examples, without limitation, for instance, be per removable element and/or color coded and/or indicated by special patterns or symbols or the like. In some examples labeling can be relatively transparent or for instance made up of thin lines, such as illustrated with reference to FIG. 19 to be described, so as to allow more of the optical elements to be seen. All manner of color or pattern or otherwise visibly distinguishable indicia marking technique are anticipated; in some cases they provide additional anti-counterfeiting protections; in some cases they are hard to change or modify from one to another; in some cases durability and ease of reading can be factors; and the markings can themselves encode a “series,” as with different banknotes denominations and/or colors or currencies of money.

The checkerboard-like indicia are an example of the wide variety of so-called two-dimensional barcode structures or the like anticipated, a whole host of which could be used here and/or adapted. The particular novel example disclosed, however, is intended to be efficient for random numbers, such as unpredictable values of cryptographic size, such as for instance of one or two or three hundred bits, as will be understood. One example coding for such random values is illustrated, where half or nearly half the squares can be filled with one color and the other half with another color or the absence of color, but the arrangement is otherwise largely random. Such arrangements can be computed efficiently with reasonably good statistics, it is believed, just by repeatedly choosing random pairs that differ and interchanging them. When creating such patterns those that have undesirable characteristics, such as no dark squares on even one edge can be skipped, as will be understood. The use of multiple colors allows the number of squares to be reduced significantly and is anticipated to be attractive as will be understood, especially since smartphone cameras have good color recognition. Redundancy in the encoded values, so called error detecting and/or correcting coding, can also help reduce errors, as will be understood.

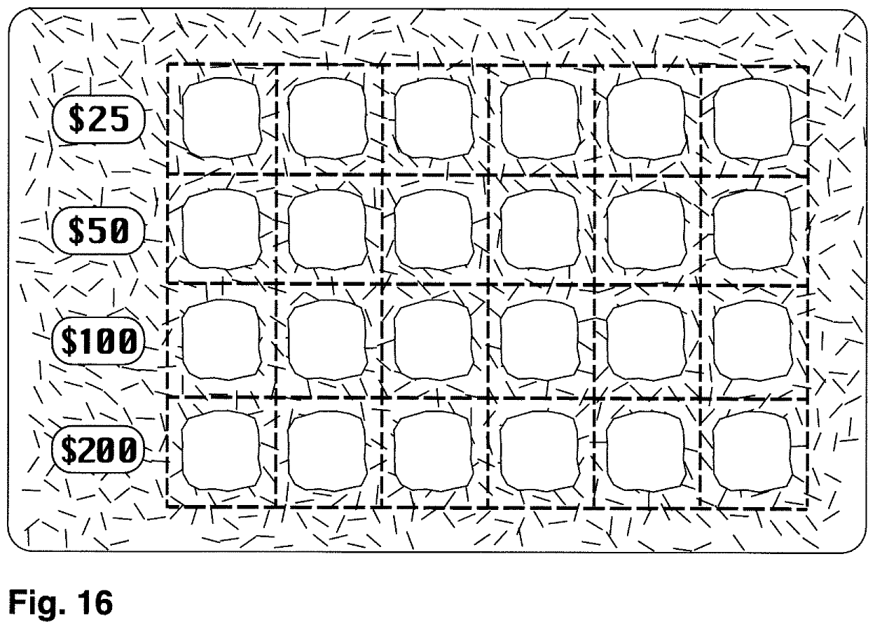

Turning next to FIG. 16, an exemplary multi-position random element structure is shown in combination plan and schematic view in accordance with aspects of the teachings of the present invention. Unlike FIG. 15, where the scratch-off is shown transparent, in this figure it is shown as opaque white for clarity. The scratch off regions cover the barcodes and thereby hide the random values of the barcodes until the respective scratch-off is removed, such technology being well known such as is used in some lotteries.

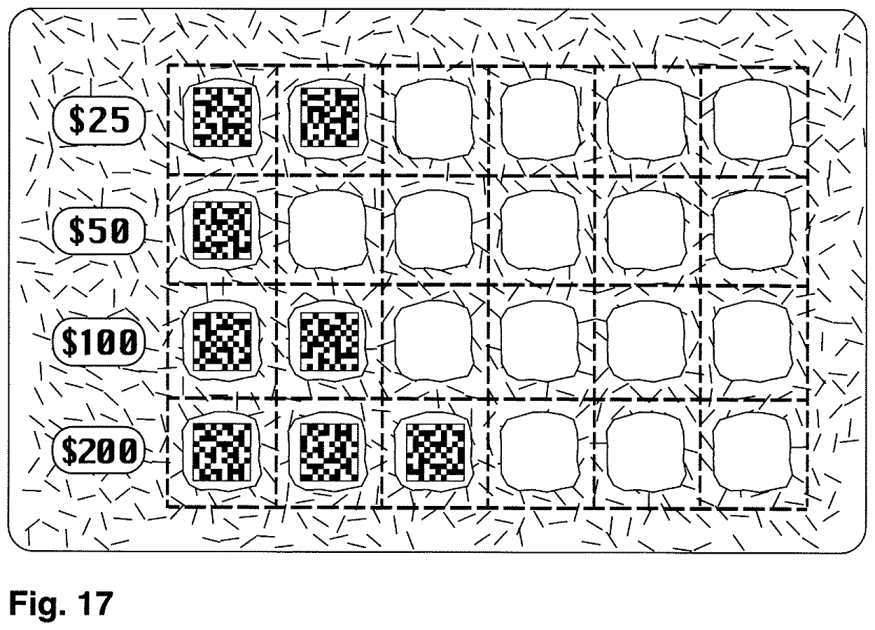

Turning to FIG. 17, an exemplary multi-position random element structure is shown in combination plan and schematic view after being partly used in accordance with aspects of the teachings of the present invention. Unlike the example described with reference to FIG. 16, where none of the scratch-off is shown removed, in this figure some example portions of the locations have been “scratched off” to reveal the corresponding barcode indicia, as will be understood.

One example use case is where the holder of the card has paid for it at approximately face value, such as the sum of all the denomination multiplicities, as will be understood. Another non-limiting use case example as will be understood that is anticipated is where the user is provided the card for free according to some allocation and/or at limited cost to prepare in case there is a network failure or some other contingency; the user could in some such examples be liable for the money spent afterwards. In some related such examples different “colors” or series of cards are issued, some for emergencies where credit is granted to the person issued the card and other series that are sold at approximately face value; such an approach is anticipated to have the advantage that the cards can be used for various offline locations and those without phones, and so forth, exercising and keeping in place mechanisms that could then be used if infrastructure failure causes the other series to be activated.

The holder in a next step shows the card to a counterparty and one or both of these party's scratches-off the region or regions to encode the amount to be paid by the holder party to the second party, as will be understood. Then as in related variations described also elsewhere here the holder device provides to the second party device, such as by local digital communication, a digital signature that includes the provenience of the card indicating that the public key with which the signature is made is possessed by the owner of the card with the random optical pattern. The signature provided also includes, as will be understood, an indication of the regions from which scratch-off has been revealed and in some examples the barcode values revealed. The signature together with provenience should serve to allow the second party to recover the funds when online, as they are believed to constitute a proof of the transfer from the holder to the second party, whose account or a one-way commit to it or public key of it or the like may be included in the signature.

Authentication of the card by the second party is achieved, in the example, including in some examples by combination of the provenience signature and random optical pattern and whatever additional related information may be provided online and/or by the parties, as will be understood and as has been explained elsewhere here as will be appreciated. A signature including the random indicia as pre-images to one-way functions in a public signed tree with Merkle proofs as described earlier here may also be advantageous.

It will also be appreciated that if the card has already been used to make one or more other transfers in a similar manner, the provenience of the signature chain can include and in effect acknowledge this and the transfer of value aspect of the signature can be limited to the barcodes and amount transferred to the particular party present at that time. The succession of signatures it is believed provides authentication of the last signature on the chain, as will be understood; however, the particular indicia revealed and amounts already spent may be present in the provenience in a compressed and/or hidden form, such as to improve for efficiency and/or privacy.

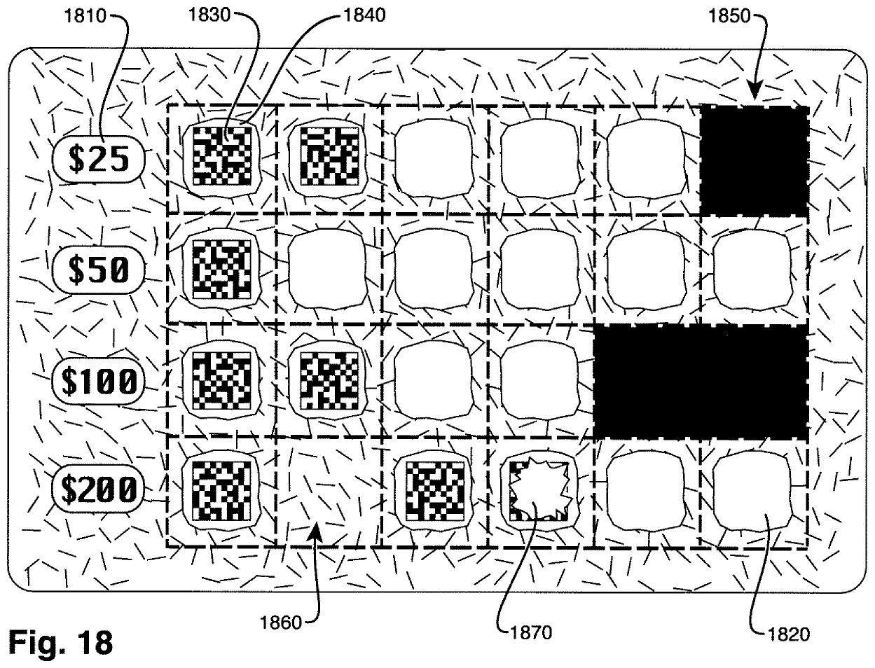

When a second party chooses the particular indicia to be used, this random choice can help exercise the security of the system; however, the orderly pattern of use shown here and the related pattern of FIG. 18 can be advantageous from a practical perspective.

If the holder party, in some examples, were to issue a “fork” in the provenience chain and give a signature to a party other than the one witnessing the scratching off, then the two branches of the fork it is believed would show fraud on the part of the holder that the card was issued to. If the card is to be provided in whole to a different party, that provenience chain provided along with it can indicate by suitable coded message signed by the original holder, it is believed to prevent uncountable future forking, that the wholesale transfer of the card has been made with the understanding that the recipient would cash it all in online.

Turning to FIG. 18, an exemplary multi-position random element structure is shown in combination plan and schematic view after being partly used and partly given to at least another party in accordance with aspects of the teachings of the present invention.

Unlike in the example described with reference to FIG. 17, where some of the scratch-off is shown removed but the card is otherwise intact, in this figure some of the locations have been what may here be called “removed,” such as for instance but without limitation by frangible provisions and/or separable structure means, as will be understood. The inventive concept includes in this example that a third party, different in some cases from the second party mentioned with reference to FIG. 17, may witness the separation and/or participate in the separation and/or conduct the separation, so that the third party may in effect at least mainly take possession of one or more portions of the card at least for some time and at least optionally have confidence that the parts came from the card.

It is anticipated as a further inventive aspect that the third party can, owing to the separation, wait some time before claiming the value related to the card portions.

It is anticipated as a yet further inventive aspect that the third party can, optionally owing to the separation, remove the scratch-off over the barcodes without exposing the barcodes to, and thereby keeping the barcodes a secret to at least a large extent from, the first party or holder. Possession of these codes can allow the third party, in some exemplary embodiments, to obtain the value when the codes are brought online. For instance, the third party itself could bring the codes online and claim the value and require it transferred to whatever device or means or account or in whatever format. By looking the indicia up, their authenticity and one-time use can be readily verified and even in a public manner, such as a transparent database and/or a blockchain. Additionally, all or part of this authentication can be provided by signatures included in information supplied by the holder.

It is anticipated as a still further inventive aspect that the third party can, owing to the separation, transfer the un-scratched-off card portion to another party. And of course, as will be understood, that party can transfer it yet further. When a party in such a what can here be called “sequence of transfers” does scratch-off the card portion, then that party can presumably obtain the value as described with reference to the present figure above. The indicia itself serves to validate to the online system. A provenience signature can validate the portion offline to smartphones or the like. In some examples and situations traditional document security features, such as easy to recognize but hard to duplicate features, like water marks, holograms, special printing, and so forth can serve to authenticate the card portion as it is passed without phones or the like, a least to some extent, as will be understood.

Indicia 1810 shows the denomination for one or more regions, in this example $25 for the top row of regions, as will be understood.

Hiding layer 1820 are shown white in this shape to indicate scratch-off or the like. In some examples, it may be advantageous for glitter or the like to be visibly included in and/or above the scratch-off material. It may even be acceptable to leave the glitter out of the card substrate in such cases.

Barcode indicia 1830 are shown initially hidden by hiding layer 1820, but exposed when for example scratched-off.

Region 1840, shown around the barcode, can for example be an under layer for concealment, roughly co-extensive with the hiding layer 1820, as is known in the higher-security, sometimes called “probability game,” scratch-off art.

Tile position 1850 illustrates a tile that has been removed. Typically, it is believed for example that such tiles can be passed at least to a party other than the current card holder. This position is shown as dark and as if frangibly separated from the perforation or other features, such as weakened structure, shown as dashed lines.

In yet another inventive aspect, some regions left intact without being removed can be un-hidden or scratched-off and the barcode information obtained by a party but made at least difficult for other parties including the card holder, to subsequently obtain. It is believed that when combined with at least having checked a suitable signature ensemble from the card holder and/or issuer image Merkle proofs or the like, the exclusive knowledge of the barcode by the party obtaining it in effect ensures no barrier, such as posed by another party claiming the value, to subsequently obtaining the value online.

Tile position 1860 is shown without barcode, and without under layer 1840; what is believed illustrated here for clarity is an example where the barcode has been destroyed and/or removed and/or made transparent, along with in this example the under layer. The hiding layer 1820 was removed, ideally by a party other than the card holder, the data captured by the party other than the cardholder and ideally without the cardholder being able to capture the data. This is believed to allow the party other than the cardholder to be relatively or just about completely certain, depending on assumptions about how well the barcode information has been hidden, that no other party can successfully claim the barcode. A signature from the cardholder confirming the location and a public key of the other than cardholder party is believed to optionally perfect the transaction further.

Barcode unreadable region 1870 is shown as approximately including all or most of the barcode and being the result of measures taken ideally by a party other than the cardholder (though it could be done by the cardholder and even not for the benefit of the third party, in order to reduce exposure to robbery of the cardholder). Examples of this what may here be called “destruction of the barcode information,” believed ideally after the data capture.

Some example ways to destroy the barcode information include mechanical, such as erasers, ink erasers, erasers with abrasive inclusions (typically known are mineral abrasives and/or glass fiber), and/or special scratch-off tools such as cooperating with a three-dimensional structure of mating hiding layer and barcode surface. Also anticipated are erasers with chemicals in them that cooperate with the barcode indicia to make it unreadable.

Other examples of destruction of information include removing the barcode, such as by detaching it or wiping it off, as with erasable gel pens is also anticipated.

Still other examples allowing water to change the color of printing is known (such as the irreversible hydrochromic inks by Colourchange PTY, of Flintshire UK). One way to use such inks/printing can be to print the barcode with water before covering with the scratch-off, so that when the whole barcode is wetted by whatever party after scratch-off, essentially the squares (or whatever shapes) that have been wetted to encode the information become essentially indistinguishable from those that were not previously wetted.

Yet further examples include inks that can simply be washed off with water, such as also made by Colourchange. Steps may be taken to choose materials so that the regions with the ink are not changed by its presence, such as protective coatings and/or pre-sublimation to simulate and/or overwhelm residue indicating application of indicia in a region.

Other example destruction of the barcode information can be by so-called irreversible indicators, such as photochromic and/or chemical indicators that are sensitive to things such as oxygen in the air, humidity in the air, temperature from scratching off, etc. are also anticipated. When the hiding layer is removed the barcode, information starts to become hard to read and ideally impossible to read after a short time.

Still yet other examples include micro-encapsulated chemicals that cause the destruction with some delay but are instigated by the protective layer being removed, such as the scratch-and-sniff sometimes included in lottery tickets. The chemicals released can react with the colorants revealing the barcode information to hide it. All manner of similar chemistry, structures, techniques and processes.

Turning to FIG. 19, an exemplary multi-position random element structure is shown in combination plan and schematic view from the reverse side in accordance with aspects of the teachings of the present invention. The example perforation lines for frangibility penetrate through the card in the example at least for clarity and the denomination labels are formed again, ideally indelibly, such as for the case when separated, and so as to in some examples advantageously minimally obscure the optical elements.

The underside of the scratch-off coatings, such as bottom layers that are known that are similar to upper layers and similar to the ink that the indicia is printed with are shown as not hiding the optical elements as seen from the bottom. It will be appreciated that this additional exposure of the elements, especially when portions of the card are separated as already described with reference to FIG. 18, can provide additional verifiability.

In some examples document security features, as already mentioned with reference to FIG. 18, can be visible from the backside to serve to help authenticate the card portion as it is passed without phones or the like, a least to some extent, as will be understood.

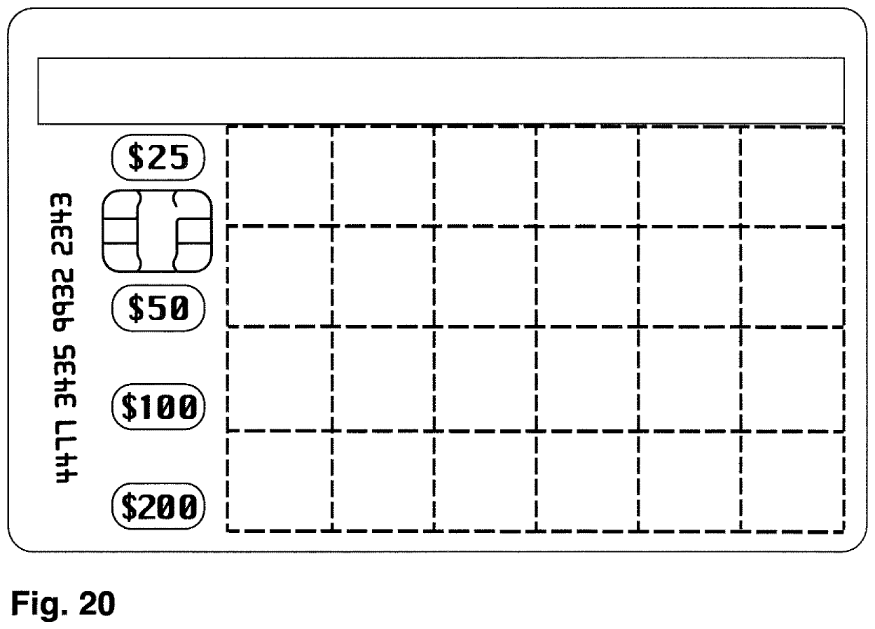

Turning to FIG. 20, an exemplary multi-position random element structure is shown in combination plan and schematic view with standard magnetic stripe and smartcard contacts in accordance with aspects of the teachings of the present invention. Various aspects of standard cards can be accommodated on either or both sides of the card in whatever combinations.

The example indicia and perforation lines are shown in a standard card format positioned so as to allow standard track 1 and track 2 magnetic stripe and EMV smartcard contacts to be included on the front of the card.

A card number is shown as an example. A user name, card number, expiration date, first issue date, and CVV, not shown for clarity, can also be included on either side of the card.

A signature panel can also be included, such as located on the back of the magnetic stripe area shown or replacing it.

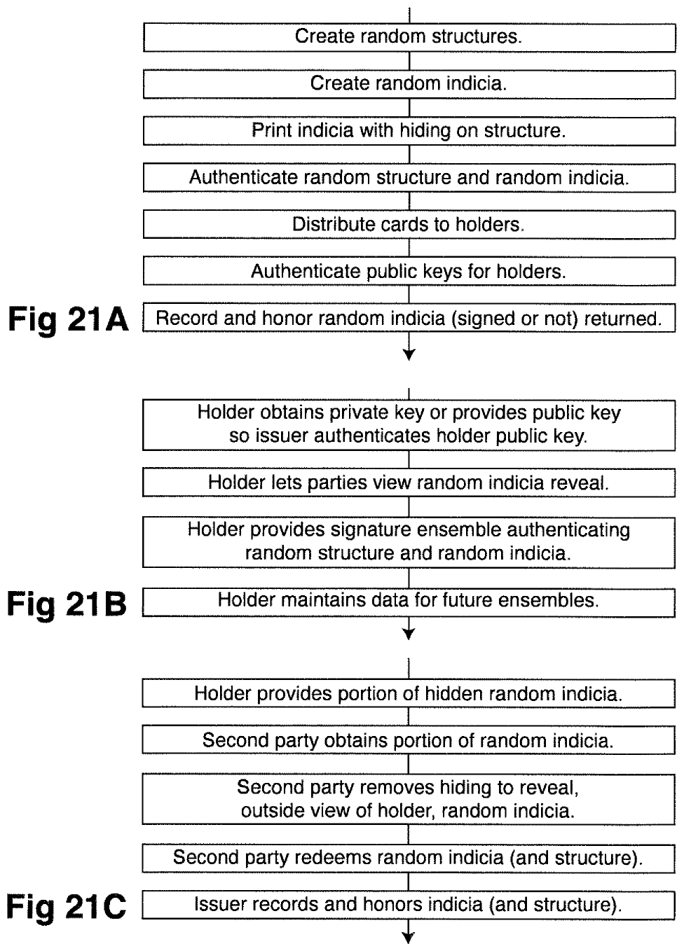

Turning finally now to FIG. 21A-C, flowcharts are shown for exemplary card embodiments in accordance with aspects of the teachings of the present invention. FIG. 21A is the issuing of a card to a holder; FIG. 21B is the spending of value by the holder with a counterparty that has a smartphone or the like; and FIG. 21C includes steps for use of removable portions of the card when smartphones or the like are not available to the counterparty.

Referring to FIG. 21A, seven steps are shown for the issuer to issue a card. As will be understood, however, any and all of these steps can be performed by a variety of parties that together can functionally serve as the issuer, such as when the parties cooperate under contract with each other and/or other entities.

First the issuer does what may be called “creates random structures.” These structures are, in some examples, the inclusion of optical elements such as glitter as described elsewhere here. A next step called here “create random indicia” is aimed at creating the unpredictable information defining the barcodes already described. Then what may be called “print indicia on structure” is a step that includes the forming of indicia by whatever means on the structure with the random optical elements already described.

Next, what may be called the “authenticate random structure and random indicia” step typically includes forming the digital authentication, such as with digital signatures, of the random structure and the random indicia and posting these online and/or providing them with the cards during issue. The hiding of the indicia, such as by cryptographic commitment scheme, as mentioned elsewhere here also, such as forming leaves of a Merkle tree, is an example that is particularly suitable for the random indicia.

When the step that may here be called “distribute cards to holders” is performed, the physical cards are made available to and/or provided to the parties that are also referred to here as the “holder” of the respective card.

The step that can be called here “authenticate public keys for holders” can be carried out in various ways, believed best resulting in the holder being able to form digital signatures that can be authenticated, through one or more additional signatures making up what can here be called “provenience signatures,” as being issued by the holder of the card. In some examples, the issuer can provide a private key to the holder, such as via a scratch-off region on the card or associated with the card, for that purpose. In some other non-limiting examples, for instance, the holder can communicate with the issuer and supply the holder public key and the issuer can form a signature authenticating that public key as associated with the particular card; that signature can be returned by the issuer to the holder, in some examples, and/or posted for instance. Other options, such as a mutual creation of the private key, such as by Diffie Hellman, and so forth are anticipated.

In the final step, the issuer can what is called here “record and honor random indicia returned.” In some examples, when the indicia returned are accompanied by what can be called here “provenience ensembles,” the issuer checks that the particular regions called out as spent do not overlap, such as by maintaining corresponding records, and credits the third party included in signatures. In other examples, when individual random codes are returned, not accompanied by provenience ensembles, then a beneficiary can be designated. This can, as just one example, be by the sending beneficiary identification or pre-images from the third party to the issuer of information that is public-key-encrypted after being concatenated with the random code, as will be understood.

When the same random indicia value is supplied in a provenience signature ensemble and separately, the provenience instance is believed the one that should be credited. (This priority is believed secure because the instances where the random codes are shown along with provenience signatures could allow the codes to be submitted as if they were seen after being separated physically; however, the converse is not believed the case, since the physical separation is ideally done in a way that precludes the holder from learning the random indicia.)

Referring next to FIG. 21B, four steps are shown for the holder to provide a provenience signature ensemble to a counter party. The first step can be said to be “holder obtains private key or provides public key so issuer authenticates holder public key.” This step is the holder side of the issuer step already described with reference to FIG. 21A.

Next the holder allows the counterparty, such as a second party, to view the removing of the hiding from one or more random indicia on the card. This may be called here “holder lets parties view indicia.” One example way to accomplish this is for the holder simply, while the counterparty is present and looking on, to scratch off or otherwise remove the hiding and allow the counterparty to capture the random indicia at that time. This way, the counterparty knows, at least with some degree of certainty, that the random indicia has not been shown to anyone else yet. Another example would be to allow the counterparty to remove the hiding in the presence of the holder, while the holder retains custody of the card, at least to some extent. One believed disadvantage to the holder of such a procedure is that the counterparty may maliciously and/or accidentally remove the hiding from more than the agreed amount or different denominations. Special means are anticipated to allow the removing under joint control.

The third step may here be called “holder provides signature ensemble authenticating random structure and random indicia.” The authenticating of the random structure, which is optional in some exemplary embodiments, as will be understood, ties the authentication to the physical card (however this could for instance be accomplished by a serial number indelibly printed on the card). The other information ideally authenticated is the random indicia that are visible. In some examples, it may be enough that the indicia exposed to the counterparty is included and any other indicia exposed can be omitted or summarized in terms of the location of the regions, as will be understood. This can, in some examples, allow the provenience to not have to grow each time value is released from the card.

The fourth step, what may be called here “holder maintains data for cumulative ensemble,” is the digital record keeping of the holder that maintains information about the private key, the random indicia already revealed, and so forth.

Referring finally here to FIG. 21C, five steps are shown for various parties to conduct a transaction with a removable part of a card. The first step can be said to be “holder provides portion of random structure.” This step is holder side of the cooperation allowing the portion of the card from the card, such as by breaking the frangible attachment, so that the third party can obtain it. The following step, called here “third party obtains portion of random structure” is the cooperating portion of the transaction performed by the third party receiving the portion. However, the transaction is divided between the two or jointly accomplished, it is covered by these two steps.

Next is what is here called “third party removes hiding to reveal outside view of holder random indicia.” This step is where the third party ideally removes the hiding, such as scratching off a scratch off layer, without the holder party being able to learn the random indicia revealed. In some examples the third party takes the portion, holds it for a period of time, and only then removes the hiding before uploading the indicia. This is here described as “third party removes hiding to reveal outside view of holder random indicia.”

At this point the third party can provide the random indicia to the issuer party or the like, such as online. At this time the third party can also reveal and/or check the random structure against the stored data and/or against digitally authenticated data, such as a Merkle signature. This can be called here “third party redeems random indicia (and structure).” The validity of this data is checked in this step. Also checked before providing value, irrevocably at least, is that the random indicia and/or structure for that portion have not been previously or contemporaneously redeemed. The fifth and final step indicated is called here “issuer records and honors indicia (and structure).” This is the step where the issuer makes sure that the indicia and structure/position are not redeemable again and the issuer provides value to the third party.

While these descriptions of the present invention have been given as examples, it will be appreciated by those of ordinary skill in the art that various modifications, alterations, alternate configurations, and equivalents may be employed without departing from the spirit and scope of the invention defined by the claims. As just one example, while a coin form factor has been called out in some examples, any portable object, including one manufactured for another purpose, can be used. Similarly, another example, mobile phones have used as example computers, but whatever devices, such as watches, tablets, laptops, built-in structures, or desktop computers or purpose built devices can be used.

1-113. (canceled)

114. A value transfer system with physical tokens including indicia hiding means and indica substantially hidden by the hiding means and the hiding being substantially removable, the improvement comprising:
a plurality of regions with substantially removable hiding means;
the hiding means substantially hiding respective indicia;
the indicia information being substantially unpredictable;
a first party providing digitally to at least a second party first transaction information at least including a provenience signature ensemble; and
the signature ensemble including at least indication of the regions with hiding removed.

115. In the system of claim 114, including: the indicia hiding means being removed at least in view of the second party and the indicia being revealed to the second party.

116. In the system of claim 115, including: the indicia information being included in the signature ensemble issued by the first party to the second party.

117. In the system of claim 116, including: the indicia being verifiable as committed to by information included in the signature ensemble.

118. In the system of claim 117, including: public key information supplied by the second party to the first party being included in the signature ensemble.

119. In the system of claim 118, including: indication being included in the provenience signature provided from the first party to the second party that the second party is to transfer the remaining value online.

120. In the system of claim 119, including: a designated party receiving custody of the physical token being responsible for forked transactions.

121. In the value transfer system of claim 120, at least a portion of the indicia information being committed to in advance of issue of tokens as leaves in a Merkle tree.

122. The system of claims 115 where the physical object is in the form substantially of a payment card.

123. The system of claim 122 where the card includes a standard at least track one and track two magnetic stripe portion in compatible position.

124. The system of claim 122 where the card includes at least a standard smart card chip in compatible position.

125. The system of claim 122 where the card includes at least substantially standard card information indicia.

126. The system of claim 115 where the physical object includes random optical structures with aspects that are included in at least one provenience signature ensemble.

127. The system of claim 115 where the physical object includes separable physical structure for transfer of the separated portion by the first party to at least a second party.

128. A value transfer system with physical tokens including indicia hiding means and indicia information hidden by the hiding means and the hiding being once-removable, the improvement comprising:
the hidden indicia being substantially unpredictable;
providing for the transfer of the separated portion by the first party to at least a second party;
providing for the removal of the hiding by the second party;
transaction processing means to receive the unpredictable indicia information from parties;
the transaction processing means verifying the unpredictable indicia information as not previously processed;
recording by the transaction processing means that the unpredictable indicia information has been processed; and
providing value at least responsive to the transaction processing means according to the respective party providing the unpredictable indicia.

129. In the value transfer system of claim 128, including: providing for the detaching act of at least one separable portion means, the detaching at least viewable by the second party;

130. In the value transfer system of claim 128, including: at least one series of hidden indicia having substantially the same face value.

131. In the value transfer system of claim 130, including: the least one series of codes having substantially a face value indicated by visible indicia included on the physical token.

132. In the value transfer system of claim 131, including: at least two series of codes, each code of a series having substantially a respective face value corresponding to the series.

133. In the value transfer system of claim 131, including: at least two series of codes, each code of a series having substantially a value corresponding to that series and that value indicated by visible indicia.

134. In the value transfer system of claim 130 including separable portion means selected from the group with non-limiting examples including: frangible molding, perforated separation lines, adhesive holding, bending fatigue breakable, and steerable structures.

135. In the value transfer system of claim 134, at least a portion of the unpredictable indicia information being committed to in advance of issue of tokens as leaves in a Merkle tree.

136. In the value transfer system of claim 135, Merkle proofs being issued by the first party to the second party.

137. The value transfer system of claim 130, wherein: a first party providing digitally to at least a second party first transaction information at least including a provenience signature ensemble; and
the signature ensemble including at least indication of the regions where the hiding means has been removed in view of the third party.

138. A method for issuing physical tokens by an issuer including the steps of:
creating physical random structures on physical tokens;
creating random indicia;
printing the indicia on the tokens with removable hiding;
authenticating the random structures and the indicia;
distributing the tokens to holders;
authenticate public keys for holders; and
recording and honoring random indicia returned with signatures corresponding to authenticated public keys.

139. A method for a holder of physical tokens to make a corresponding transfer of value including the steps of:
authenticating holder public key;
letting second parties view revealed hidden indicia;
providing signature ensemble authenticating random structure and revealed indicia; and
maintaining data for future ensembles.

140. A method for physical transfer of physical tokens to make a corresponding transfer of value including the steps of:
holder providing a portion of random indicia;
second party obtaining a portion of random indicia means;
second party removing, outside view of holder, hiding means to reveal random indicia;
second party redeeming random indicia;
issuer recording and honoring indicia issued and returned.

141. In the method of claim 140, second party providing random structure information along with indicia redeemed.

142. In the method of claim 140, issuer recording random structure information.

143. In the method of claim 140, issuer giving priority to a payment made with provenience signature over a payment made by random indicia alone.
